(19) United States
(12) Patent Application Publication
(10) Pub. No.: US 2007/0043152 A1
(43) Pub. Date: Feb. 22, 2007

(54) Isocyanate-based compositions, process for using them, use thereof for making direct-to-metal coatings and coatings thus obtained

(76) Inventors: Jean-Marie Bernard, Saint Laurent D'Agny (FR); Philippe Barbeau, Genas (FR)

Correspondence Address: Jean-Louis Seugnet;Rhodia Inconprorated, 259 Prospect Plains Road, CN -7500, Cranbury, NJ, 08512, US

(21) Appl. No.: 10/557,875

(22) PCT Filed: May 14, 2004
(86) PCT No.: PCT/FR04/01197

§ 371 Date: Nov. 18, 2005

(30) Foreign Application Priority Data
May 21, 2003 (FR) 0306094
May 11, 2004 (FR) 0405084

(51) Int. Cl. C08K 5/06; C08G 18/08; B05D 3/12; B05D 3/02; B05D 7/00

(52) U.S. Cl. 524/366; 524/589; 427/372.2; 427/421.1; 427/355

(57) ABSTRACT

The invention relates to the use of an emulsifying agent and compositions containing same. The aforementioned emulsifying agent comprises at least one compound selected from among those with an anionic functional group and a polyoxygenated chain having a carbon number which is at most equal to 25 and, preferably, 20. The invention is suitable for coatings, such as paints and adhesives.

The present invention relates to compounds and compositions based on isocyanates (which may be partially masked, but this is not the preferred embodiment). The invention is also directed toward the process for using them, their use for making coatings and coatings thus obtained. The invention more particularly relates to compositions that are (self-)dispersible in aqueous phase.

To understand the invention more clearly, it would appear appropriate to recall the following.

Thus, in some of its implementations, the present invention refers to the dual-cure technique. It is thus desirable to recall the principles thereof.

Dual curing is a technique in which a composition comprising double bonds (which are usually activated, for example acrylate groups), functions containing labile hydrogen and isocyanate functions, which may be masked, is subjected to two modes of curing, i.e. a polymerization of the double bonds and a condensation of the isocyanates with the function containing labile hydrogen (alcohol, amine or thiol). An example of this is given below.

After preparation of a “2K” composition, it is applied to the support and the coating is then cured by means of a sequence of two reactions.

1) Curing of the double bond, for example by UV:

Isocyanate grafted acrylate+polyol grafted acrylate→polyacrylate with free isocyanate and hydroxyl functions.

Drying under a UV lamp in the presence of a photo-chemical reaction initiator; this reaction is very fast, and makes it possible to obtain a coating that is dry to the touch, i.e. the components can be handled on leaving the production line, resulting in a certain gain in production efficiency.

2) Polyurethane reaction:

The second step is a standard reaction between the polyol acrylate and the free isocyanate groups, which gives rise to the formation of urethane bonds. This reaction takes place at room temperature, or may be accelerated by stoving as in the case of polyurethanes. This second curing gives the coating the final properties.

This dual system moreover has the advantage of ensuring minimum curing of the coating, even in the areas of shadow that might not be reached by the UV radiation, which is the case for certain nonplanar components.

The case of a two-pack acrylate+isocyanate is close to that described above, except that the isocyanate does not comprise any acrylate groups; the coating will be cured under UV by means of the unsaturations present on the polyol polymer, and the isocyanate will then react with the hydroxyl groups of the polyol to form a polyurethane; this case is not considered in the strict sense as a dual-cure system. But it is not far off!

In the context of the present invention, these systems may be used in the presence of an emulsifier described below bearing another curable system, generally based on a double bond.

In the present description, the particle size characteristics often refer to notations of the type dₙ in which n is a number from 1 to 99; this notation is well known in many technical fields, but rather more rare in chemistry, and it may thus be worthwhile recalling its meaning. This notation represents the particle size such that n % (by weight, or more exactly by mass, since the weight is not an amount of material but a force) of the particles is less than or equal to said size.

In the rest of the description, the polydispersity index will be used, which is defined as:
I=(d₉₀−d₁₀)/d₅₀
Although these definitions are in the dictionaries, it may be useful to recall a few definitions relating to dispersions.

“Dispersion”: liquid medium comprising at least two phases in which the solid or liquid (or even gaseous) particles of a phase termed the “discontinuous” phase are dispersed in a “continuous” liquid phase.

“Emulsion” corresponds well to its etymology (“emulgare=to milk” of the same I.-E. root as “Milch” in German) and is a generalization of the concept of milk: liquid medium consisting of particles (globules or droplets) of liquid dispersed in another liquid phase.

“Suspension”: liquid medium consisting of particles of a solid phase dispersed in a liquid phase.

Thus, “emulsion” and “suspension” form part of “dispersions” and are subsets thereof.

“To emulsify” and “to emulsion” are synonymous. This is likewise the case for the respective derivatives thereof.

In addition, mention should be made of the intuitive concept of “self-emulsifying”.

“Self-emulsifying” (=self-emulsifiable): is said of a product or a composition capable of forming, in the presence of a liquid medium in which said composition is immiscible, an emulsion via a spontaneous mechanism. In the mechanism of spontaneous emulsification, the energy required to form an emulsion concerns only the energy required to redistribute the material to be emulsified in the mixture: thus, there is no need for external energy, essentially stirring energy, to create the emulsion. For further details, reference may be made to the article by Minou Nabavi et al.: “Dynamics of spontaneous emulsification for fabrication of oil in water emulsions”: [Langmuir, 2000, 16, 9703-9708]. In other words, the energy required for stirring that ensures macroscopically uniform distribution of the discontinuous phase is more than sufficient (for example manual stirring).

Until very recently, the vast majority of isocyanates were essentially dissolved in organic solvents. The use of organic solvents is increasingly coming under criticism by the authorities in charge of safety at work, since these solvents, or at least some of them, are notoriously toxic or chronotoxic. This is why attempts are increasingly made to develop techniques that contain little solvent, or even that are solvent-free. In particular, to overcome the drawbacks related with solvents, complex compositions are sought, occasionally referred to as systems, which can replace mixtures in solvent medium.

In particular, to reduce the use of organic solvent, the presence of which is well known as being toxic to those handling it and harmful to the environment, it has been proposed to develop isocyanate compositions that are both readily emulsifiable and readily usable as an emulsion in water. In this case, the water serves as a “vehicle” for the components of the formulation and makes it possible to reduce, or even dispense with, the organic solvents required especially for adjusting the viscosity.

As regards the isocyanates, the ones most commonly used are the diisocyanates, especially the alkylene diisocyanates (for example those sold under the brand name Tolonate®) especially in the form of oligomeric derivatives thereof, such as those containing a biuret unit, those containing a uretidinedione unit, those containing unit(s) derived from various trimerizations or capable of being derived therefrom. The various units or rings that may be formed during trimerization may be recalled: 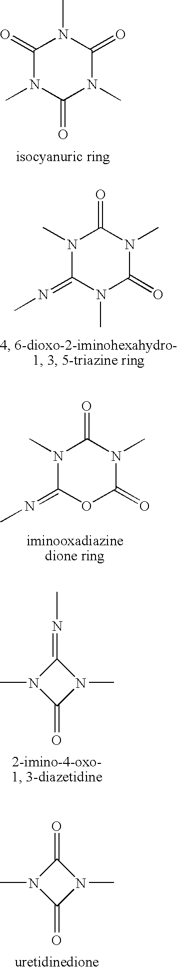
Although the present invention can be used in fields other than that of coating (especially adhesives, paints and varnishes), in the rest of the description its application in paints and varnishes will be used to more clearly explain the problem and to serve, where appropriate, as a typical example.

In order to understand the scope of the invention more clearly, especially in the field of paints and varnishes, it is worthwhile recalling a little the techniques and systems used to reduce or dispense with the use of organic solvent.

Thus, to make films of paints or of polyurethane varnishes, a mixture is prepared comprising a dispersion, on the one hand, usually an emulsion, containing the isocyanate, and a dispersion or a solution of di- or polyfunctional coreagent (of function bearing reactive hydrogen, see below), generally polyols, on the other hand. Given the reactivity of the free isocyanate function, the isocyanates are usually masked. When such is not the case, the free isocyanates are usually placed in emulsion directly in the dispersion of coreagent.

Such functions bearing reactive hydrogen, also referred to as functions containing labile hydrogen (noted as Ψ-H below), contain a hydrogen that is termed labile and are such that the reaction of equation (1) below takes place, possibly followed by the reaction of equation (2):
-L-Ψ-H+OCN-→-L-Ψ-C(O)—N(H)— (1)
-L-Ψ-C(O)—N(H)—+OCN—→-L-Ψ-C(O)—N(C(O)—N(H)—)— (2)

in which L represents the bond with the rest of the molecule;

in which Ψ represents a chalcogen (advantageously oxygen or sulfur) or a trivalent nitrogen or phosphorus atom, or even an arsenic and even an antimony atom.

When the hydrogen, in particular of hydroxyl, is acidic (pKa at most equal to 6, usually to 5), a subsequent decarboxylation reaction may take place. Thus, the carboxylic functions may themselves give acylureas (in point of fact, the most common reaction sequence is as follows: the addition of isocyanate leads to the dissymmetric acid anhydride of the carboxylic acid and of the carbamic acid corresponding to the isocyanate; this anhydride decarboxylates to give the amide of said carboxylic acid and the amine corresponding to the isocyanate;

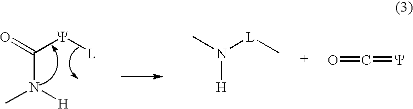

A second isocyanate function may then react with the amide (equation 2) to give an acylurea when L is carbonyl (—CO—). This reaction explains the formation of urea during the addition of water to isocyanate, reaction 2 then gives biuret; is in this case a chalcogen, usually an oxygen, and L is such that L-Ψ-H is an acid (cf. above), L usually being carbonyl.

Ψ may also represent a nitrogen atom bearing a hydrogen or a hydrocarbon-based radical (i.e. a radical comprising hydrogen and carbon) of not more than 15 carbon atoms, but, in this case, reaction 3 does not take place.

L is advantageously chosen from a single bond (−), carbonyl groups [—C(═O)—, including NH₂—C(═O)], groups of imino type (>C═N— and —C(═N—)— [for example to form amidines, amidoximes (—C(═N—O—H)—NH₂) or a conjugated form of amides]).

These functions are well known to those skilled in the art and, among the latter, mention may be made of functions containing an amino group (in which Ψ represents >N—), which, besides amines and anilines, comprise amides [in which Ψ is preceded by a carbonyl group to give —C(═O)—N<] with, as special cases, lactams and ureas, functions containing a hydroxyl group [in which Ψ represents —O—], which, besides alcohol functions, including phenols, comprise oxime functions [in which Ψ is preceded by an imino group to give ═N—O—] oxygenated acid with a pKa at least equal to 1, advantageously equal to 2 and preferably to 3, in particular carboxylic acid functions [in which Ψ is preceded by a carbonyl group to give —C(═O)—O—] and thiol functions.

The pigments and the various fillers and additives are usually present or introduced into the aqueous phase bearing the coreagent (generally polyol) before introduction of the isocyanate; however, they may be introduced after the formation of the double dispersion.

The isocyanate may be free or masked and, in the latter case, totally or partially masked. The present invention is especially directed toward the case where at least some of the isocyanate functions are unmasked.

A related aim of the present invention is to facilitate the dispersion of the optional pigments and fillers, and especially of titanium dioxide (rutile or anatase).

Once the final dispersion is complete, it is then spread onto a support in the form of a film using standard techniques for using industrial coatings, especially paints and varnishes.

When the preparation contains masked isocyanates, the film+support assembly is brought to a temperature sufficient to ensure the conversion of the film [release of the isocyanate functions and/or condensation thereof with compounds having functions containing reactive hydrogen which are well known to those skilled in the art (amine, sulfhydryl, hydroxyl, in other words alcohol or even carboxylic function, etc. functions)], in general hydroxyl function, of the coreagent. It should be recalled, however, that the masked or blocked products have a significantly higher cost price than unmasked products.

Thus, one of the solutions most commonly proposed lies in the use of dispersions, especially emulsions, in water. On account of the reactivity of water with isocyanates, this solution is especially used for masked isocyanates.

Needless to say, these problems must be resolved while respecting the constraints intrinsic to coatings.

For example, in order not to jump out of the frying pan into the fire, a major hazard must be avoided, i.e. that of deteriorating one or more of the essential qualities of coatings [maintaining the smooth nature and avoiding the “orange peel” defect, the hardness, the resistance to solvents, the adherence to any support, etc.].

In particular, poor adherence of the coating to its support should be feared. The reason for this is that many surfactants are notorious for impairing the strength of the bond between the coating and its support and are known and used to undermine the attachment between a polymer and a support. Such phenomena are described especially in DE-OS 3 108 537.

Usually, when unmasked or incompletely masked isocyanates are used, in the form of an aqueous emulsion, the time for which they may be used remains less than a few hours, generally one or two hours. It is important that the use of novel emulsifiers should not be reflected by a significantly reduced service life on contact with an aqueous phase.

Thus, it is important not to encounter any difficulties during the dispersing operation, especially of isocyanates in emulsion.

To satisfy the above constraints, it has been proposed to graft onto a polyisocyanate a polyethylene oxide chain beginning with an alcohol, by reacting an isocyanate function with an end alcohol function of said chain. The compounds thus obtained are quite easy to emulsify, but the size of the polyethylene oxide chains to be incorporated and above all the number of ethylene oxide units remains very high and ipso facto considerably reduces the content of isocyanate functions per unit of mass, by dilution on the one hand, and by consumption of the isocyanate functions by the alcohol functions on the other hand.

The proportions of ethylene oxide required (usually about 15% to 20% by mass) and used very significantly impair the mechanical and physical properties both of initial and immediate compositions and of the final coating when such compositions are used to obtain a coating (especially adhesives, but above all paint and varnish). They do, admittedly, constitute efficient emulsifying agents. Although they are often presented as such, they are not strictly speaking self-emulsifying agents, since they require quite vigorous stirring.

This is why it is desirable that the present invention should provide compounds and compositions that have properties at least equivalent to the above compounds and that thus make it possible, by mixing in water, or more precisely in an aqueous phase, to obtain a stable emulsion; it is also desirable that the dispersion should be formed without it being necessary to use special techniques and/or installations in order to do so.

Another constraint that the present invention must respect is that of providing compounds and compositions of the above type that do not disrupt the coating operations or alter the coating qualities.

Another aim of the present invention is to provide compositions of the above type whose solvent content is as low as possible and, for the case of hexamethylene diisocyanate derivatives, less than 1/5 and advantageously 1/10 by mass of said composition. Needless to say, it is preferable for there to be as little as possible, and even none at all.

The use of certain anionic compounds containing a polyethylene oxide sequence, as is recommended in the French patent application published under the number 2 745 577 dated Feb. 29, 1996 and in the PCT patent application published under the number WO 97/31960, constituted important progress and has made it possible to respect these constraints, at least qualitatively.

However, it is a matter of molecules that remain heavy, especially on account of the large size of the lipophilic group. It follows that the amounts required to ensure self-emulsification remain relatively high.

This is why one of the aims of the present invention is to provide a novel category of emulsifiers, which, when used with isocyanates, especially bearers of free isocyanate functions, i.e. of formula —N═C═O, are capable of readily giving a dispersion and especially an aqueous emulsion.

More specifically, another aim of the present invention is to provide a novel category of emulsifier of the above type that is capable of readily giving a dispersion and especially an aqueous emulsion, at a mass concentration of not more than 0.1 times the mass of the isocyanate composition used.

Another aim of the present invention is to provide a novel category of emulsifier that does not facilitate the attack of the free isocyanate functions by water during the emulsification (the continuous phase being aqueous) and thereafter.

Another aim of the present invention is to find an emulsifier that affords a strong bond between the coating and its support and promotes attachment between a binder and a support.

Another aim of the present invention is to provide an emulsifying agent that makes it possible to obtain dispersions with a high content of isocyanate function (mass of the isocyanate function=42), especially at least equal to 5% of the total mass of the dispersion.

Another aim of the present invention is to provide a composition comprising both an isocyanate and an emulsifying agent, which, by a simple homogenization operation, forms a physically stable dispersion.

At this point in the description, it is worthwhile returning to the problem of adherence.

A subject of the present invention is also a technique for improving the adhesion, and then the adherence, to a mineral support. A subject of the invention is more particularly a technique for simplifying and/or especially avoiding certain steps and/or certain layers preparatory to the final layer of coating. This technique will be referred to hereinbelow as “direct-to-metal coating”. It is referred to in the literature by the abbreviation “DTM”.

It is worthwhile firstly returning to the problem of adhesion and adherence to mineral supports or substrates.

The term “mineral” should be understood as meaning any material not comprising an organic material as major structural component.

More particularly, the problems and the solution outlined below are especially directed toward materials that have undergone a melt state before being formed. Among these materials that have passed through a melt state before being formed, mention should be made of materials of glassy nature, and especially glass, and also mineral compounds of crystalline nature, for instance metals in the metallic state.

The terms “adherence” and “adhesion” first need to be defined.

Adhesion (root corresponds to the past participle and thus to an event that is generally finished) corresponds to the passage from the nonadhesive state to the adhesive state, in the case outlined herein the fluid composition, which is the precursor of the coating, comes into contact with the surface of the substrate and then forms a network by physical or chemical bonding (polycondensation) by binding strongly to the surface of the substrate; adherence (root corresponds to the present participle and thus to a continuing phenomenon) means the property of the layer of coating on the substrate and especially its capacity to resist being detached from the substrate.

The adherence of a coating to a support depends firstly on the coating itself, which is generally organic, and secondly on the surface of the support and more particularly on the preparation thereof to receive the coating.

This problem of adherence of the coating to the support is all the more difficult to present since there is not always a clear semantic frontier between the various operations leading to the coating (preparation of a surface, application of precoats, primers and final coats) and the coats corresponding thereto.

In certain applications, the primer is referred to as a “laminant” or “size”.

Despite its age, mention should be made, as a reference text for the concepts, of the manual written by Pierre Grandou and Paul Pastour (both volumes), namely: P. Grandou and P. Pastour: PEINTURE ET VERNIS [PAINTS AND VARNISHES]:
I constituents (1966 ISBN2 7056 5520-4 and 5884x)
II techniques and industries (1969 ISBN2 7056 59359)
   and published by Hermann publications.

Among the problems that are difficult to deal with, mention should firstly be made of a problem of compatibility between mineral surfaces and organic coats. This is why transition coats are currently used in the state of the art, which make it possible gradually to go from an entirely mineral system to an entirely organic system.

Another problem to be solved, especially in the case of metals, comes from the fact that metals develop corrosion layers, usually of oxides, which are not always very adherent to the metal from which they are derived. In this case, if the coating lies on the oxidized layers coating the metal, the adherence of the coating to the metal cannot be greater than the adherence of the oxides to the metal.

Needless to say, the adherence of a coating to a metal depends on the specific surface area of the metal covered and also on the shape of the surface. Thus, surfaces containing small alveoli can facilitate the adherence of the layer to the substrate provided that the machine (or the binder) is capable of penetrating said alveoli.

Another major problem of the adherence of a coating to a metal substrate lies in the oxidation, once the coating has been applied, of the substrate. Specifically, the crystallographic structure of the oxidized metal is generally very different from the structure of the initial metal, thus implying a change in physical properties, volume and density, the change in physical properties causing very significant losses of adherence during the aging of the substrate/coating layer assembly.

This is why any change in the oxidation state of the metal should be avoided once the coating layer has been applied. To do this, two measures are commonly taken, firstly creating an impermeable layer that insulates the metal from the oxidizing agents, whether they are liquid, gaseous or even solid. Another measure is to treat the metal so as to inhibit its corrosion.

Finally, it should be pointed out that the coating of glass is notoriously difficult on account of the particularly flat and smooth nature of the usual glass surfaces and of similar surfaces, for instance vitrified ceramics.

To better define the problem, the main steps of the surface treatment and of the coating should now be described, in the order in which they must be performed, given that in many cases they are not all obligatory.

The first step of the surface treatment consists in removing the layers of low cohesion that might hinder the adhesion and then the adherence of the coating layer (as examples, reference may be made to the book by P. Grandou and P. Pastour, PAINTS AND VARNISHES II, techniques et industries pour le fer [techniques and industries for iron], page 46 et seq., under the sub-heading preparation des surfaces pour l'aluminium [preparation of surfaces for aluminum]. Pages 64 to 67 should be referred to). These layers of low cohesion are, on the one hand, greases, and, on the other hand, some of the oxides that form at the surface of the substrate to be coated. The greases are easily removed by means of degreasing techniques that are well known to those skilled in the art, for instance the use of solvents for greases.

The oxides, and even the greases, may also be removed by mechanical or chemical stripping. These stripping techniques are well known to those skilled in the art, who may make use of techniques such as abrasion, but also techniques for attacking the surface oxides using a chemical agent capable of dissolving the oxides and concretions that have formed on the surface of the metal. This chemical attack may be chosen with agents that facilitate the restoration of a good-quality oxidized metal layer. It may also in certain cases increase the specific surface area of the substrate. At this stage, it is possible to cover the metal with a protective layer of another metal, usually zinc (see, for example, P. Grandou and P. Pastour, techniques et industries, page 34, final paragraph to page 35, ante-penultimate paragraph).

In a second stage, the surface oxidation products are subjected to a conversion operation (for aluminum see P. Grandou and P. Pastour, techniques et industries, pages 67 to 69). This conversion operation, which may take place either on the oxides obtained after stripping, or directly on the oxides that have naturally formed on the surface of the substrate, is directed toward forming a layer separating the metal from the external medium, based on derivatives of the oxides derived from the metal. This layer is, on the one hand, as adherent as possible to the metal and, on the other hand, is also as impermeable as possible and avoids the development of corrosion on the metal surface. The best conversion agents are chromium derivatives and especially chromates. However, this solution is strongly criticized on account firstly of the environmental problems associated with the emission of chromium derivatives on nature, and secondly on account of its cost.

Other systems also give good results, especially phosphates and orthophosphoric acid derivatives, or even higher phosphoric acid derivatives (for example, pyrophosphoric acid).

To replace chromium derivatives, rare earths have been proposed, which give relatively satisfactory results. It has also been proposed to use silica derivatives and especially silanes and siloxanes; mention should also be made of anodization.

As regards the use of earths, mention may be made, for example, of the article by J. O. Stoffer et al. presented at the “International Waterborne, High-Solids, and Powder Coatings Symposium” on Feb. 10 to 12, 1999. As regards the corrosion protection of motor vehicles, reference may be made to the article by Horst Gehmecker entitled “Automotive Corrosion Protection Practices in Europe” published in 1997 by the “Society of Automotive Engineers, Inc.”, pages 1241 to 1248. As regards conversion using silanes, reference may be made firstly to the article “Pretractamamiento Basado en Silanos” by Terrie Child and Chris Miller published in the review “Pinturas y Acabados”, pages 18 to 20, and the article “Application of Silane Technology to Prevent Corrosion of Metals and Improve Paint Adhesion”. For the conversion techniques, reference may be made, especially as regards phosphate on metal supports, to the technical review established by Yu. I. Kuznetsof in “Protection of Metals”, Vol. 37, No. 2, 2001, pages 101-107. Also, reference may be made to the two preceding articles. The layer thus formed is known as the conversion layer.

Various coating layers are applied onto this conversion layer. The first of the films applied is referred to as a primer film, or quite simply as a “primer”, which generally contains, besides the binder, anticorrosion compounds for the cases where there is mechanical rupture of the coating layer or film.

Among these anticorrosion components that may be mentioned are zinc phosphate, ferrous oxide and various types of pigments dispersed in the binder. Mention may be made especially, although it is seldom used on account of its toxicity, of minium, but also barium oxide and dehydrating agents. The efficacy of the pigments depends on their shape factor, and thus phyllitous pigments (i.e. leaf-shaped pigments such as micas) give good results.

In certain cases, the primers, and especially those known as “wash primers”, may contain as filler compounds which, when used alone, are known to ensure conversion (for example potassium zinc chromate or lead chromate).

The primer ensures the progressiveness from the mineral layer to the organic layer. In other words, it ensures a sort of gradient of organic materials from the all-mineral substrate layer to the coatings that are for the most part purely organic. Conventional binders are based, for example, on:

polyurethanes;

epoxy resins;

polyester resins;

acrylic resins;

alkoxyamine derivatives.

There are several ways of applying the primer coats. One of the most common ways is the technique known as cataphoresis. After the primer, the finishing coat(s) is(are) generally added. A basecoat that bears the color and that comprises the pigments and the binders, which are occasionally cured using isocyanates.

On top of the basecoat is added a coat of varnish (transparent coat whose aim is to protect the basecoat. The basecoat and the varnish coat may be one and the same coat; this coat is known as a finishing coat and is occasionally referred to as a “topcoat”.

The isocyanate compositions according to the present invention may be either in the primer coat or in the basecoat, or in the varnish or in one or more of the abovementioned coats.

The present invention is directed toward the use of compositions as defined hereinbelow, and the provision of an isocyanate composition that allows better adherence to untreated substrates, and in particular to incompletely treated substrates.

One aim of the present invention other than those that have been detailed above is to provide an isocyanate composition that can be used in a basecoat without there being any primer.

Another aim of the present invention is to provide an isocyanate composition that can be used in a basecoat or in a topcoat without there being any primer or any conversion coat.

Another aim of the present invention is to provide an isocyanate composition that can be used in a primer but without there being any conversion coat.

Another aim of the present invention is to provide an isocyanate composition of the above type(s) that can be used in the form of an emulsion in an aqueous phase.

Another aim of the present invention is to provide an isocyanate composition of the above type(s) that shows good behavior in the test of wet-medium resistance.

These aims, and others that will appear hereinbelow, are achieved by means of the use of an emulsifier comprising at least one compound from those containing one (in the sense of at least one) anionic functional group (occasionally referred to subsequently as an “anionic function”) and one, and advantageously only one, polyoxygenated chain whose carbon number is not more than 25, advantageously 23 and preferably 20. Such a compound, or mixture of compounds if there are several of them that satisfy the definition, will occasionally be referred to hereinbelow by the abbreviation “CGFA”.

Obviously, said emulsifier is used together (usually dissolved in the isocyanate phase, especially when it is liquid, when it is not in the presence of water, especially for storage) with an isocyanate phase, often referred to in the rest of the description as an “isocyanate-function vector subcomposition” or “isocyanate subcomposition”. The isocyanate functions of this isocyanate phase may be free (i.e. of formula —NCO) or masked. However, they are advantageously at least partially free (advantageously at least ⅓ of them, preferably at least 50% and more preferably at least ⅔ are free) or totally free (at least 95% and even 99% or more of them are free).

The minimum catenary carbon number (i.e., of course, belonging to said polyoxygenated chain) is 4, advantageously 6 and preferably 8.

The electrical neutrality of said compound is ensured by protons and/or mineral or, preferably, organic cocations.

Although that of the cocations is admittedly not negligible, the essential role is played by the anionic part of the compound. This is seen implicitly in the drawing of formula (II) in which the cocation is not shown. To overcome the problem associated with the enormous variability of the cationic masses and thus to understand the invention more clearly, in the rest of the description, only the mass of the protonated anion of said compound will be taken into account for the mass values (such as percentages and ratios). Thus, for the calculations, all the mass values will be based on the acid form of said compound (the most acidic in the case of multiple anionic charges).

Said compound advantageously comprises not more than three anionic functional groups, preferably not more than two and, for reasons of ease of synthesis, most usually one.

The anionic functional group is advantageously chosen from oxygenated anionic functional groups. The term “oxygenated anionic functional group” means a group comprising at least one oxygen, which (at least in one mesomeric form) advantageously bears a negative charge.

The anionic functional group advantageously comprises one of the atoms of columns VB (the phosphorus column) and VIB (the sulfur column) from a period at least equal to the third and at most equal to the fifth. This atom may also be a carbon, but this is not a preferred embodiment of the invention.

As an illustrative example, mention may be made, as anionic functional group, of those with phosphate functionality [i.e. in formula (I) below: E=P; X and optionally X′ being oxygen and m=1 and p+q=2], phosphonate functionality [i.e. when X or optionally X′ is a single bond; m=1 and p+q=2], phosphite functionality (m=0, X and X′ being oxygen) or phosphinate functionality (i.e. when q is 1, X and X′ being a single bond and m=1 and p+q=2).

As has been provided for above, one anionic functional group may be linked to others. Thus, in formula (I) below, X′ may be oxygen and R11 to give a bond with another anionic functional group. When m is equal to 1, the sum p+q is equal to 2 and the two anionic functional groups are of phosphate functionality, a pyrophosphate derivative is obtained. As is presented later, such compounds may be formed in situ from ester phosphate in the presence of a dehydrating agent such as the isocyanate functions.

If X′ is a single bond and if R11 is a divalent carbon-based chain unit, a diphosphonate may be obtained if said chain unit is directly linked to a phosphorus V.

The Periodic Table of the Elements used in the present patent application is that of the supplement to the Bulletin de la Société Chimique de France, January 1966, No. 1. The associated acid (the first acidity when the anionic functional group is anionic twice [i.e. when p is equal to 2]) of the anionic functional group advantageously has an acidity with a pKa of not more than 5 and preferably not more than 3.

When said chain is linked to said anionic functional group via an atom from columns VB (the nitrogen column) and VIB (the oxygen column) from a period at least equal to the second and at most equal to the fifth, and especially an oxygen or a nitrogen, this atom will be acknowledged as belonging to said anionic functional group rather than to said chain. In the other cases and especially in the case of carbon, the atom will be acknowledged as belonging to said chain.

The anionic functional groups advantageously correspond to formula (I) below:

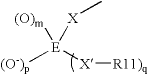

in which E is one of the atoms from columns VB (the phosphorus column) and VIB (the sulfur column) from a period at least equal to the third and at most equal to the fifth, or even a carbon atom;

in which X represents a single bond, an oxygen, or even a nitrogen, which is advantageously substituted; this substituent is advantageously a hydrocarbon-based radical, preferably aryl or alkyl, or even acyl; and bears the open bond to attach said anionic group to the rest of the molecule;

in which X′ is chosen from a single bond and a metalloid, and especially and advantageously an oxygen; or even a nitrogen, which is advantageously substituted; this substituent is advantageously a hydrocarbon-based radical, preferably aryl or alkyl, or even acyl;

in which R11 represents a hydrogen; another polyoxygenated chain identical to or different than that which will be attached to X; a hydrocarbon-based group (advantageously of not more than 5 and preferably of not more than 3 carbon atoms), optionally bearing at most one other identical or different anionic functional group or a single bond providing a bond with another identical or different anionic functional group;

in which q represents 0 or 1;

in which p represents an integer between 1 and 2 (closed intervals, i.e. including the limits);

in which m represents 0 or an integer between 1 and 2 (closed intervals, i.e. including the limits); with the condition that:

p+q+2m+1 is equal to 6 or 4 and that:
when E is a chalcogen (column VIB), q is equal to zero and the sum when E is an element from column VB (the phosphorus column), the sum p+q is equal to two and the sum p+q+2m+1 is equal to 5 or 3, advantageously 5.

It should be mentioned that, in the present patent application, the case where “q” is equal to one, where “p” is equal to one, where X′ is an oxygen and where R11 is equal to H, is considered as being the same as the case where “p” is equal to 2 and “q” is equal to zero. The only difference lies in the state of neutralization and it is only possible since the cocation is not specified. For the calculations presented later in the description, it will be considered, in the case where R11 is H, that “q” is zero and that “p” is equal to two.

Advantageously, according to the present invention, said compound containing an anionic functional group has the formula (II) below:

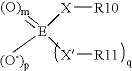

in which R10 represents said polyoxygenated chain (this term means that said chain comprises at least two and advantageously three oxygen atoms).

Advantageously, the number of carbons in said chain is linked to the number of oxygens and optionally to the number of nitrogens (if any, but usually there is no nitrogen in said polyoxygenated chain) by the following relationship:
nb_{C}≦a·(nb_{O}+nb_{N})+4,

with nb_{C} representing the number of carbon atoms in said chain;

with nb_{N} representing the number of nitrogen atoms in said chain;

with nb_{O} representing the number of oxygen atoms in said chain.

The factor “a” is not more than 3, advantageously less than 3 and preferably less than 2.5.

As regards the lower limit of the number of carbons in the polyoxygenated chain, it is desirable that:
nb_{C}≧b(nb_{O}+nb_{N})+1,

with the factor “b” at least equal to 1, advantageously to 1.5 and preferably to 1.7.

The oxygen atoms counted by nb_{O} are the catenary atoms (i.e. those belonging to said chain) belonging to carbonyl, ether and ester functions (when the ester functional group comprises carbonyl functions, they are counted with the carbonyl functions specified previously), or even, when E is other than carbon, hydroxyl functions, especially of an acid with a pKa of greater than 3 (one significant figure), advantageously carboxylic.

The nitrogen atoms are the catenary atoms belonging to amine functions (advantageously tertiary) and/or amide functions (advantageously peralkylated).

The carbon atoms are the catenary atoms of any type.

Said chain advantageously comprises at least one fragment of at least one alkene oxide (or alkenyloxyl) unit, advantageously at least two and preferably at least three.

The (oligo-)alkene oxide fragment(s) of said chain comprise(s) in total at least 2, advantageously at least 3 and preferably at least 4 alkenyloxyl units

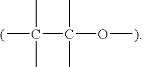

The (oligo-)alkene oxide fragments of said chain advantageously comprise not more than 8 and preferably not more than 7 alkenyloxyl units

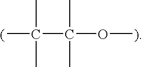

These alkenyloxyl units are advantageously chosen from propylenoxyl [—CH₂—CH(CH₃)—O—] (it may be noted that, when the alkenyls of the alkenyloxyls are not palindromic, the sequences are either head-to-head, head-to-tail or tail-to-tail) and ethylenyloxyl [—CH₂—CH₂—O—]; it is preferable for the latter units to be in predominant amount.

As will be detailed hereinbelow and as is common, when the emulsifier comprises several compounds of formula (II), the values of “nb”, “a” and “b”, p or even “m” and, as will be seen later, “n”, may be fractional. This may especially reflect the fact that said chain contains a random sequence of alkene oxide(s). In this case, the mean formula is a numerical mean (total number of atoms, or of units, of each type divided by the number of chains). The weights of each molecule may be measured by high performance liquid chromatography, complemented where necessary by proton NMR and, whenever possible, NMR of the atom E, especially of phosphorus. Use may also be made of the MALDITOF technique (abbreviation for Matrix Assisted Laser Desorbtion Ionization Time of Flight).

It should be noted, however, that when the molecules of formula (II) contain in the vast majority (at least 90% by mass) the same number of anionic groups, acidimetry gives very acceptable similar results, especially when E is an atom from column VB, especially phosphorus.

As has been mentioned previously, one aim of the present invention is to provide an emulsifier comprising at least one compound containing an anionic functional group that is capable of giving with isocyanates a self-emulsifying composition, even with low contents of emulsifying compound(s) according to the invention.

Thus, it is desirable that the threshold at and above which the property appears should be as low as possible. It is desirable for this threshold to correspond to a mass content of compound(s) according to the invention (as has already been mentioned, without taking into account the cocation corresponding to the base used for the neutralization) relative to the composition obtained (including the cocation) at most equal to 10%, advantageously to 6% and even to 5%.

When it applies to direct-to-metal coatings, the invention is particularly useful for covering glass surfaces, including vitrified surfaces, and surfaces derived from metals and alloys that will be detailed below.

When it applies to direct-to-metal coatings, the composition according to the present invention may be used in non-water-based paints (in general dissolved in a solvent) like in water-based paints.

However, it is in the use in emulsion form that the invention is the most advantageous.

As substrate, mention should be made firstly of ferrous alloys, including iron, the various grades of steel and alloys between iron, on the one hand, and one or more metals or metalloids chosen from nickel, cobalt, chromium, manganese, molybdenum, vanadium and tungsten, carbon, or even nitrogen (nitridation).

These ferrous alloys may be covered with a cement coat (carbonized iron) or zinc according to any of the techniques known to those skilled in the art.

The present invention may also be used on substrates based on aluminum or aluminum alloys, i.e. alloys comprising at least 30% aluminum and preferably at least 50% aluminum. These alloys, especially, may be formed with one or more of the following metals: copper, tin, zinc and, where appropriate, small proportions of arsenic or antimony.

The invention may also be used on nonferrous alloys based on (i.e. comprising at least 30% and advantageously at least 50%) copper or lead. It may also be used on these pure metals.

The present invention may be used directly, with or without primer, with or without conversion coat on the substrates defined above, but it is preferable to remove the layers of low cohesion beforehand.

According to one particularly advantageous embodiment of the present invention, the binder composition obtained from the compositions according to the present invention comprises at least ¼ and advantageously ⅓ of the mass of the binder, of mineral material of acicular and/or phyllitous form and whose shape factors are high. The reason for this is that it appears that the compositions according to the present invention are particularly suited to such forms.

Another aim of the present invention is to provide a compound or a mixture of compounds according to the invention, which, when mononeutralized, is(are) amphiphilic, i.e. present(s) dual solubility: on the one hand in aqueous phase and on the other hand in organic phase, in this case isocyanate.

Another aim of the present invention is to provide an amphiphilic compound or mixture of compounds whose solubility in organic phase is at least equal to 5% by mass (as already stated not taking the cocation into account).

Another aim of the present invention is to provide an amphiphilic compound or mixture of compounds whose solubility in aqueous phase is advantageously at least equal to 5% by mass (as already stated not taking the cocation into account).

These aims, and others that will become apparent hereinbelow, are achieved by means of using compound(s) containing an anionic functional group and a polyoxygenated chain whose carbon number is not more than 25 and advantageously 20, corresponding to formula (II) below: 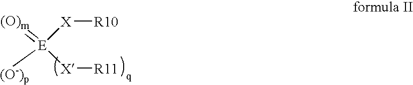
in which E, X, X′, R11, p, q and m have the same values as above,
in which R10 represents a polyoxygenated chain comprising at least two alkenyloxyl units and not more than eight alkenyloxyl units, said alkenyl-oxyl units being chosen from propylenoxyl units [—CH₂—CH(CH₃)—O—] and ethylenyloxyl units [—CH₂—CH₂—O—], the latter units advantageously being at least equal in number to the propylenoxyl units;
and with the condition that the number of carbons in said chain R10 is linked to the number of oxygens and optionally to the number of nitrogens (if any, but there is usually no nitrogen in said polyoxygenated chain) by the following relationship:
   nb_{C}≦a·(nb_{O}+nb_{N})+4;
with nb_{C} representing the number of carbon atoms in said chain;
with nb_{N} representing the number of nitrogen atoms in said chain;
with nb_{O} representing the number of oxygen atoms in said chain;
the factor “a” being less than 3, advantageously not more than 2.5 and preferably not more than 2.3.

As regards the lower limit, it is desirable that
nb_{C}≧b(nb_{O}+nb_{N})+1,
with the factor “b” at least equal to 1, advantageously to 1.5 and preferably to 1.7.

In order for good self-emulsification to take place, it is desirable, firstly, for E to be an atom from column VB (advantageously phosphorus) and, secondly, in the polyoxygenated chain R10, advantageously throughout said compound of formula (II), for the ratio between the number of ethylenyloxyl units and the number of alkenyloxyl units, obviously including ethylenyloxyl, to be at least 2/3, advantageously 3/4 and preferably 100%.

It is also desirable for this constraint to be applied to all of said compound according to the present invention (i.e. containing an anionic functional group and a polyoxygenated chain). When the emulsifier contains several compounds according to the present invention, especially of formula (II), it is also advantageous for this condition to apply randomly to all of the compounds according to the present invention, present in the emulsifier.

When the radical R11 represents a polyoxygenated chain, it is desirable for R11, which is identical to or different than R10, to be chosen from the same family of polyoxygenated chain and even to satisfy the same preferred conditions. However, it is preferable for R11 to be H or for q to be equal to zero.

To better define the preferred choices specified above as regards the polyoxygenated chains, and at the risk of being superfluous, the preferred polyoxygenated chains according to the present invention may be defined as being hydrocarbon-based chains having the following characteristics:
a carbon number of not more than 25, advantageously not more than 20 and preferably not more than 18 (when the chain bears, directly or indirectly, several anionic functional groups, these values must be based on the anionic function),
at least 2 and advantageously at least 3 oxygen atoms;
some of the preferential but optional characteristics:
   one or more ether functions are advantageously intercalated in carbon-based sequences, each ether function being separated from its closest neighbor by advantageously at least 2 carbons;
   one or more carbonyl functions are present in said polyoxygenated chain, advantageously chosen from amide functions, optionally peralkylated, and preferably esters;
   the ether functions of said polyoxygenated chain are advantageously at least partially formed from alkenyloxyl units, the latter preferably being chosen from ethylenyloxyl and propylenoxyl;
   the terminal group of said chain when it is linear, or otherwise the longest sequence, is advantageously a group of lipophilic nature but of small size, this size being limited by the relationships between nb_{C}, nb_{O} and nb_{N}. This end group is limited on one side, obviously, by the end of the polyoxygenated chain, and on the other side by the end of the carbonyl group(s), the oxygen atom(s) of ether or ester functions, or the nitrogen atom(s), which is the closest to the end of the chain. Although the possibility of it being hydrogen cannot be excluded, it is desirable for this end group to be a hydrocarbon-based group comprising at least one and advantageously two carbons, and when the limit of the end group is an oxygen engaged in an ether function, said end group comprises up to eight carbons and preferably up to six carbons. The latter limits are also advantageous in the other cases;
   said end group is advantageously limited by a carbonyl group (the carbon of the carbonyl function is not included in the calculation of the carbon number of said end group), preferably the carbonyl of an ester; according to one advantageous embodiment of the present invention, said end group may form with the carbonyl an acyl group; as is presented hereinbelow, the acyl group may bear an unsaturation or an unsaturated system (for example an aryl, optionally bearing a double bond) conjugated with the carbonyl.

According to one mode that is well suited to coating and especially to paints and varnishes, the compound containing an anionic functional group also comprises a functionality capable of giving curing separate from that obtained by the condensation of the isocyanate function with a function containing reactive hydrogen. Such another function may be a double bond or several double bonds (carbon═carbon), which are advantageously activated:
either with a donor atom [nitrogen or oxygen as in the case of N-vinyls (for example N-vinyl-pyrrolidone) or vinyl ethers or esters];
or with an electron-withdrawing group, especially carbonyl, phosphonic or nitrile;
or with a double bond or an aryl;
or, obviously, with a combination of the above means (for example a cinnamyl radical).

Such a system makes it possible to produce a dual-cure system, which, in the case of the present invention, improves the adherence to certain substrates and reduces or avoids the phenomena of rising of material to the surface of the coating, which is occasionally observed on contact with aqueous phases or a humid atmosphere.

This curing may be obtained by polymerization:
either of double bonds borne solely by the emulsifier,
or of double bonds borne by the emulsifier and by an isocyanate (pre)functionalized so as to bear a reactive double bond,
or of double bonds borne by the emulsifier and by a coreagent (e.g. polyol bearing an acrylic function),
or of double bonds borne by the emulsifier, by a coreagent and by an isocyanate (pre)functionalized so as to bear a reactive double bond.

This curing takes place under conditions known to those skilled in the art, by actinic initiation (electron bombardment, X-ray, UV) and/or thermal and/or chemical initiation optionally in the presence of an appropriate activator or catalyst.

In the context of this embodiment, the double bond may be in the polyoxygenated chain and especially in the end group. However, it may also be in the anionic functional group and especially in R11 [for example in the case of vinyl mono- (one anionic functional group) or di-phosphonate (two anionic functional groups) bearing a polyoxygenated chain as targeted by the present invention].

According to one of the preferred embodiments according to the present invention, the polyoxygenated chains (which may thus correspond to R10 and to R11 when the latter is defined as being a polyoxygenated chain) according to the present invention correspond to formula (III) below: 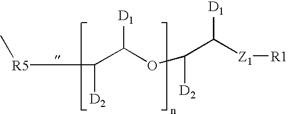
in which the multivalent radical R5 forms part of the polyoxygenated chain and provides the bonding between the chain and 1 (it is then divalent), 2 (it is then trivalent) or even 3 (it is then tetravalent) anionic functional groups; it thus represents an arm comprising at least 1, advantageously at least 2 and not more than 4 carbon-based chain units, optionally bearing another anionic functional group;
in which n is an integer chosen between 0 and 7, advantageously between 2 and 6 and preferably between 3 and 5 (closed intervals, i.e. including the limits);
in which the values of D₁ and D₂ may be different depending on the chain units and are chosen from methyls and hydrogens and cannot simultaneously be methyl; the sum of the carbon atoms of the various groups D₁ and D₂ being not more than n/2 and advantageously n/4. Advantageously, all the groups D₁ and D₂ are hydrogen;
in which Z₁ is a hydrophilic divalent radical chosen from:
   oxygen atoms (forming an ether function) or nitrogen atoms (nitrogen advantageously not bearing hydrogen), carbonyloxyl divalent functions [—O—CO— or —CO—O— as in esters] and amide functions [—N—CO— or —CO—N—] including urethane and urea,
   the divalent carbon-based groups, of up to 6 carbons, bearing at each end functions chosen from ether, amine advantageously not bearing hydrogen, carbonyloxyl (O—CO—) or oxylcarbonyl (—CO—O—) (such as ester), amide advantageously not bearing hydrogen, or even ketone or aldehyde functions, said divalent carbon-based groups possibly bearing a double bond advantageously conjugated with at least one of the functions forming the end of said group;
in which R1 represents said advantageously lipophilic end group and is chosen from hydrogen and hydrocarbon-based radicals, advantageously chosen from optionally substituted alkyls, or even aryls. Thus, although the possibility of it being hydrogen is not excluded, it is desirable for this end group to be a hydrocarbon-based group comprising at least one and advantageously two carbons and, when the limit of the end group is an oxygen engaged in an ether function, said end group comprises up to eight carbons and preferably up to six carbons. This limit is also advantageous in the other cases. As will be seen in the rest of the description, it is advantageous for R1 to bear a double bond;

R5 is usually linked to the rest of the oxygenated chain via an oxygen that forms part of said R5.

For reasons of coherence, it should be mentioned that if R5 represents a 1,2-propylenoxyl unit [—CH₂—CH(CH₃)—O—] or an ethylenyloxyl unit [—CH₂—CH₂—O—], it will be considered as forming part of the polyethyleneoxyl chain and will be counted as a unit included in the number n and therefore R₅— will merely define a single bond.

As has already been mentioned previously, the molecule of formula I may comprise one, or even more, double bond(s). Such double bonds may then be either in the part X′-R11 [for example when X′ represents a single bond and when R11 is an optionally substituted vinyl] or in the polyoxygenated chain targeted by the invention.

In the latter case, if it is desired for it to be able to give rise to a second cure, it is preferable for the double bond to be in the part Z₁-R1 of formula (III).

Thus, for example: Z₁ is chosen from

oxycarbonyl

amide

O—CO—CH═CH—CO—O

O—CO—C(CH₃)═CH—CO—O

O—CO—C(═CH₂)—CH₂—CO—O

—O—

oxycarbonyloxyl

—O—CH₂—CH(OCO—CH═CH₂)—CH₂—O—CO—

and R1, advantageously of not more than 8 carbon atoms, is chosen from:
optionally substituted vinyls, especially methyl-vinyl and phenylvinyl;
light alkyls of not more than 8 carbon atoms, especially methyl, ethyl, propyl or butyl;
vinylphenyl (-Φ-CH═CH₂);
or even hydrogen.

Preferably, one or even both of the groups Z₁ and R1 contains at least one double bond.

The following sequences may thus be present:

| | | Examples, |
|---|---|---|
| | | observations or |
| Z₁ | R1 | common name |
| Oxycarbonyl | Vinyls, including | (Meth)acrylic |
| (—O—CO—) | alkylvinyl and | ester, |
| | arylvinyl | cinnamic ester |
| | | and equivalents |
| Amide | Vinyls including | (Meth)acrylamides |
| | alkylvinyl and | cinnamide |
| | arylvinyl | |
| O—CO—CH═CH—CO—O | Methyl, ethyl, | Maleate or |
| | propyls, butyls, | fumarate |
| | or even hydrogen | depending on the |
| | | geometry |
| O—CO—C(CH₃)═CH—CO—O | Methyl, ethyl, | Methyl, ethyl, |
| | propyls, butyls, | propyl or butyl |
| | or even hydrogen | citraconate, or |
| | | even hydrogen |
| O—CO—C(═CH₂)—CH₂—CO—O | Methyl, ethyl, | Itaconate |
| | propyls, butyls, | |
| | or even hydrogen | |
| —O— | Vinylphenyl | Vinylphenyl ether |
| —O— | Vinyls, including | Vinyl ether |
| | alkylvinyl and | |
| | arylvinyl | |
| Carbonyloxyl | Vinyls, including | Vinyl ester |
| | alkylvinyl and | |
| | arylvinyl | |
| O—CH₂—CH(OCO—CH═CH2)—CH2—O—CO | Vinyls, including | Glyceryl ether |
| | alkylvinyl and | bisacrylate |
| | arylvinyl | |

Examples of the synthesis of such compounds may be found in the published patent applications WO 01/74909 and WO 00/27890.

The preferred value for E is phosphorus.

When E is phosphorus, the most efficient molecules are especially those comprising only one polyoxygenated chain per anionic functional group (i.e. when R11 is not a polyoxygenated chain or when “q” is equal to zero) and it is even preferable for R11 to be at least partially in H form, or for “p” to be equal to two, but for the second acidity to be at least partially in protonated form. Molecules containing two polyoxygenated chains are less efficient.

Given the difficulty of making them in pure form, the compounds according to formula (II) are usually used in the form of a mixture of molecules of similar formulae, of which a statistical formula, or mean formula, is given, which explains why the value especially of “n” can be fractional. In particular, the phosphoric esters corresponding to the present invention are often synthesized from chains containing random polyalkene oxide blocks, the number of units of which is statistical and corresponds to a fractional “n”.

This is also true for the other numerical values of formula (II) and for the ratio between the various alkenyloxyl chain units.

This is particularly true when E is a phosphorus and above all when the anionic groups are of phosphate nature (i.e. when the phosphorus is pentavalent and is directly linked only to oxygens).

In the case of complex mixtures, it is preferable to refer to a statistical formula in which, in formula (II), m, p and q are fractional and are chosen within the following respective ranges:

where q is chosen within the range from zero to 1;

where p is chosen between 1 and 2 (closed intervals, i.e. including the limits);

where m is chosen between zero and 2 (closed intervals, i.e. including the limits), advantageously m is an integer (give or take the variation caused by the impurities).

In general, in these mixtures, E represents a single value and corresponds to only one element. Under these conditions, the constraints associated with the elements are found for the one-element mixtures, in the forms below:
when E is a chalcogen (column VIB), m is between one and 2, advantageously equal to 1 or 2, preferably to 2; q is equal to zero and the sum p+q+2 m+1;
when E is an element from column VB (phosphorus column), m is between zero and 1, advantageously equal to zero or 1, preferably to 1; the sum p+q is equal to 2; and the sum p+q+2m+1 is within the closed interval (i.e. containing the limits) ranging from 3 to 5, advantageously equal to 3 or 5, preferentially to 6.

It is desirable for the statistical value of “p” and that of “q” to be such that q/(p+q) is not more than 1/4, advantageously 1/6 and preferably 1/8.

It is thus preferred to use mixtures of molecules of formula (II) which, optionally based on an anionic functional group, contain less than two polyoxygenated chains.

Statistically, it is thus desirable for there to be, per anionic functional group, not more than 3/2, advantageously not more than 4/3 and preferably 5/4 polyoxygenated chain. The most efficient system is when there is from 0.8 to 1.2; advantageously from 0.9 to 1.2 polyoxygenated chain per anionic functional group.

Thus, when X′=oxygen and R11 is a polyoxygenated chain, it will be considered that the above condition may be written: the statistical value of “p” and that of “q” must be such that q/(p+q) is not more than 1/4, advantageously 1/6 and preferably 1/8.

The majority (i.e. at least half by mass, advantageously at least 2/3, preferably at least 3/4 and more preferentially 9/10, or even all) of said emulsifier advantageously consists of one or more molecules according to formula (II).

It is also desirable for at least 40%, advantageously at least 50% and preferably at least 75% by mass of said emulsifier to correspond to a formula (II) in which R11 is other than a polyoxygenated chain and preferably to correspond to a formula (II) in which “q” is equal to zero.

Another aim of the present invention is to provide a composition comprising free isocyanate functions in a content at least equal to 3% by mass (the mass of an isocyanate function being 42), advantageously at least 5% and preferably 10%, which is readily emulsifiable in water.

Another aim of the present invention is to provide a composition of the above type that is self-emulsifying.

Another aim of the present invention is to provide a composition of the above type whose emulsion size (d₅₀) can be regulated by means of the amount of emulsifier.

These aims, and others that will emerge hereinbelow, are achieved by means of a composition based on isocyanate(s), which is(are) advantageously not completely masked (see amount of free isocyanate above), characterized in that it comprises at least one compound containing one (in the sense of at least one) anionic functional group (occasionally referred to hereinbelow as “anionic function”) and one, and advantageously only one, polyoxygenated chain with a carbon number of not more than 25 and advantageously not more than 20.

Said compound advantageously comprises not more than 3 anionic functional groups, preferably not more than 2 and, for reasons of ease of synthesis, usually 1.

The anionic functional group is advantageously chosen from oxygenated anionic functional groups comprising atoms from columns VB (the phosphorus column) and VIB (the sulfur column) of a period at least equal to the 3rd and at most equal to the 5th. The Periodic Table of the Elements used in the present patent application is that of the supplement to the Bulletin de la Société Chimique de France, January 1966, No. 1. The associated acid (the first acidity when the anionic functional group is anionic twice [i.e. in the case of formula (I), p is equal to 2]) of the anionic functional group advantageously has an acidity with a pKa of not more than 5 and preferably not more than 3 (1 significant figure).

Thus, the present invention is directed toward, for successive or simultaneous addition, a composition especially comprising:
a) a subcomposition that is a vector of isocyanate functions, the preferred characteristics of which are specified hereinbelow;
b) an emulsifier containing at least one compound containing an anionic functional group and a polyoxygenated chain with a carbon number of not more than 25 and advantageously not more than 20; and
c) optionally, an aqueous phase.

According to the present invention, said compound, or mixture of compounds, containing an anionic functional group and a polyoxygenated chain may be used alone or as a mixture with one or more surfactants.

These optional surfactants may be chosen from other ionic compounds [especially aryl and/or alkyl sulfate or phosphate (needless to say, aryl especially includes alkylaryls and alkyl especially includes aralkyls), aryl or alkyl phosphonates, phosphinates and sulfonates, fatty acid salt and/or zwitterionic salt] and, among nonionic compounds, those that are or are not blocked at the end of the chain.

However, the nonionic compounds containing alcoholic functions on at least one of the chains appear to have a slightly unfavorable effect on the (self-)emulsion, even though they have a favorable effect on other aspects of the paint composition; taking this into account, it is preferable for the content of this type of compound to represent not more than a third, advantageously not more than a fifth and preferably not more that a tenth by mass of said anionic compounds according to the invention).

Returning to the compounds according to the present invention, said compound(s) thus advantageously comprise(s) a hydrophilic portion formed from said anionic function, from said (optional) polyethylene glycol chain fragment and a lipophilic portion based on a hydrocarbon-based radical.

Said hydrophilic portion is generally chosen from alkyl groups [in the present description, ALK-yl is taken in its etymological sense as a hydrocarbon-based residue of an ALKAN-ol after disregarding the alcohol (or -ol) function]; and aryl groups.

The structural preferences for the compounds according to the present invention have already been presented, but it may be advantageous to go over certain points again, or even to complete them.

Thus, when E represents a carbon atom (advantageously in this case m=1 and p=1), the prototypes of these compounds derived from this choice correspond, for example:
to a polyethoxylated alcohol acid [for example polyethoxylated lactic acid or glycolic acid, with, for example, q=0; X a single bond; R10 corresponding to formula (III) in which R5 is the alcohol acid residue after disregarding the carboxylic function, the other values being unchanged]; or
to a polyethoxylated amino acid [for example a natural amino acid containing less than 8 carbon atoms (such as glycine or alanine); with, for example, q=0; X a single bond; R10 corresponding to formula (III) in which R5 is the amino acid residue after disregarding the carboxylic function, the other values being unchanged) polyethoxylated).

As has already been mentioned, these compounds in which E is a carbon are not preferred, but may serve as precursors for hydroxy-diphosphono compounds via the action of a phosphorus III compound on carboxylic functions. See especially EP 104 974 for the technique for converting the carboxylic function and EP 38 764 for the esterification technique.

E may be chosen from atoms giving pnictides of a row higher than nitrogen (elements from column VB) (advantageously in this case, m=1 or 0; and p=1 or 2) and chalcogen atoms of a row higher than oxygen (advantageously in this case, m=1 or 2 and p=1 and q=0). The elements of column VB are preferred, and more particularly phosphorus.

Thus, when E is a chalcogen, formula I advantageously simplifies to: 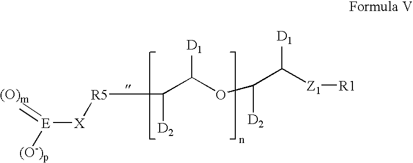
with p equal to 1 and m being equal to 1 and advantageously to 2.

Advantageously, E represents carbon and especially phosphorus or sulfur, preferably phosphorus.

In the case of phosphorus, formula (III) becomes: 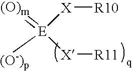
with, when q is zero, formula (III) becomes the formula: 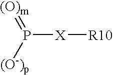
in which p represents 2;
in which m represents 0 or 1;
in which the sum p+m is not more than 3;
in which the sum 1+p+2m is equal to 3 or 5; the latter value being preferred;
   with the advantageous values m=1 and p=2.

Advantageously, the preferred formula (V) comprises a phosphorus and becomes: 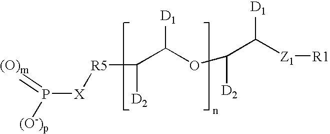
in which n, X, R5, D₁, D₂, Z₁ and R1 are defined as above.

As has been mentioned previously, when R5 is ethylenyl-oxyl or propylenyloxyl, it is considered as forming part of the polyalkenyloxyl chain and is included in the count of “n”. Formula V then becomes formula (VI): 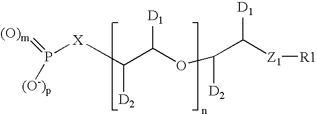
in which the part between the square brackets: 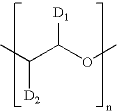
   represents a sequence formed from the homopoly-condensation of ethylene oxide or from the heteropoly-condensation of ethylene oxide and propylene oxide;
“n” is advantageously chosen such that the total number of alkenyloxyls in the assembly X—R10, on the one hand, and, where appropriate, in the assembly X′-R11, on the other hand, ranges from 1 to 8 and advantageously ranges from 2 to 7. It is also desirable for “n” to have a value of not more than 6 and at least equal to 2, preferably between 3 and 5 (closed intervals, i.e. including the limits).

It should be pointed out that from a position outside the conventions of the present description, which considers that X or X′ does not form part of the polyoxygenated chain, it may be considered that the fragment 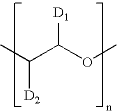
may be juxtaposed with a unit such that there is in the molecule a polyalkenyloxyl sequence that comprises one unit more than “n”, this being the case when one of the conditions below is met:
either when X is an oxygen: the combination of X and of the polyoxygenated chain (i.e. X—R10) may then be written: 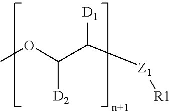
or when Z1 is an oxygen or a bearer of an oxygen containing two simple functions so as to form an alkenyloxyl unit with the optionally substituted ethylenyl group (not between the square brackets and to the right of the right-hand square bracket), and given by the sequence (—CHD₁-CHD₂-). If Z₁ is then written in the form O-Z′1, the sequence X—R10 may be written as the formula

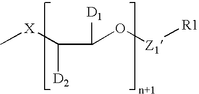

This comment explains why the constraints regarding the number of alkenyloxyl units in the branch X—R10 can involve a different value of “n” depending on the case.

The Periodic Table of the Elements used in the present patent application is that of the supplement to the Bulletin de la Société Chimique de France, January 1966, No. 1.

The optional functionalization of the alkylenes (which may especially be the case for R5 and Z₁) is performed via hydrophilic functions (tertiary amines and, when this is provided for in the above description, via other functional groups).

The counter-cation(s) that ensures the electrical neutrality of the compounds according to the invention is advantageously monovalent and is chosen from mineral cations and organic cations that are advantageously nonnucleophilic and consequently of quaternary or tertiary nature [especially “oniums” of column V such as phosphonium, ammoniums (including protonated amines), or even of column VI such as sulfonium, etc.] and mixtures thereof, usually ammoniums, generally derived from an amine, advantageously a tertiary amine. Advantageously, it is avoided for the organic cation to have a reactive hydrogen with the isocyanate function. This explains the preference for tertiary amines.

The mineral cations may be sequestered with phase-transfer agents, for instance crown ethers.

The pKa in water of the cations derived from the protonation of the neutral bases (organic [ammonium . . . ] or mineral bases) is advantageously at least equal to 7, preferably to 8 and not more than 14, preferably not more than 12 and more preferentially not more than 10.

The cations and especially the ammoniums corresponding to the amines (protonated amines in this case) advantageously do not have any surfactant properties, but it is desirable for them to have good solubility, or in any case sufficient solubility to ensure the solubility of said compounds containing a functional group and a polyoxygenated chain, in aqueous phase and at the working concentration.

The tertiary amines and the quaternary ammoniums or phosphoniums containing not more than 16, advantageously 12, advantageously not more than 10 and preferably not more than 8 carbon atoms per “onium” function (it is recalled that it is preferred for there to be only one per molecule) are preferred.

The amines may comprise other functions and especially functions corresponding to the functions of the amino acids and of the cyclic ether functions, for instance N-methylmorpholine, or otherwise. These other functions are advantageously in a form that does not react with the isocyanate functions and does not significantly impair the solubility in aqueous phase.

It is very desirable for the anionic compounds according to the present invention to be in a neutralized form such that the pH it induces during dissolution or placing in contact in water is at least equal to 3, advantageously to 4, preferably to 5 and not more than 12, advantageously not more than 11 and preferably not more than 10.

Thus, it is preferable for only the strong or medium-strength acid functions (i.e. those with a pKa of not more than 4) to be neutralized when there is more than one of them. The weak acidities, i.e. those with a pKa of at least 5, may be partially neutralized.

As has been mentioned previously in more general terms, it is preferable for the compound(s) in which “q” is zero to be in largely predominant amount. Thus, when E is a phosphorus V (i.e. 2m+p+q=5) and when the mixture of compounds is ester, it is desirable to use mixtures of monoester(s) and of diester(s) in a mono-ester/diester molar ratio of greater than 2, advantageously greater than 3, preferably greater than 4 and more preferentially greater than 5, or even greater than 10.

The emulsifiers according to the invention, especially the above mixtures, may also comprise from 1% to about 20% (however, it is preferable for this not to exceed about 10%) by mass of phosphoric acid and/or phosphorous acid (which will advantageously be at least partially salified so as to be within the recommended pH zones) and from 0 to 5% of pyrophosphoric acid esters not included in the invention. Although, technically, the presence of phosphorous acid is possible, it may arise that some of its derivatives are considered to be toxic and, in this case, it should obviously be avoided.

The mass ratio between the emulsifiers (including the anionic functional group and a polyoxygenated chain) and the isocyanates is very preferably between 1/20 and about 1/10. The recommended zones will be specified hereinbelow.

The composition may also comprise a catalyst, advantageously a latent catalyst (which may be released by the action of external agents, for example visible or UV radiation, or oxygen).

When it contains double bonds, the composition may also comprise a double bond polymerization promoter, which is advantageously a latent promoter (which may be activated by the action of external agents, for example visible or UV radiation, or oxygen).

According to the present invention, it is possible to readily produce a stable emulsion and especially a stable oil-in-water emulsion.

Admittedly, it is possible to obtain a “water-in-oil” emulsion, but such an emulsion is chemically sparingly stable. “Water-in-oil” emulsions promote a hazardous and occasionally abrupt decomposition of isocyanate functions. To avoid this problem, it is recommended to add the isocyanate composition according to the invention to the aqueous phase rather than the reverse.

When the emulsifier concentration is low, it may arise that demixing takes place to give two emulsions, an oil-in-water emulsion on which is a water-in-oil emulsion. This situation may be overcome by more vigorous stirring or by increasing the emulsifier content.

It is desirable for the isocyanate composition according to the invention to have, after dispersing or emulsifying in an aqueous phase, a water content of not more than 95%, advantageously not more than 90% and preferably not more than 85%, and of at least 20% and advantageously at least 25%. It is thus possible to obtain emulsions that are rich in solid matter.

In particular, the solid matter content may reach values at least equal to 50%, and even 60%, but it is generally less than 80%.

The ease of emulsification depends on the viscosity of the isocyanate composition before addition of (i.e. without) emulsifier. To obtain fine particle sizes, or to obtain high solids contents, it is preferable to use an isocyanate composition with a viscosity (under normal temperature and pressure conditions) of not more than about 9000 centipoises (or milliPascal·seconds), advantageously about 5000 centipoises (milliPascal·seconds), preferably 3000 and more preferably 1500 centipoises (or milliPascal·seconds), or even 1000 mPa·s. In point of fact, the lower the viscosity, the better the propensity to form emulsions.

To return to the problem of emulsification, in the course of the study that led to the present invention, it was shown that there was a risk of runaway of various reactions when certain water proportions were reached. This is particularly true in the case of aliphatic isocyanates, i.e. isocyanates linked to the hydrocarbon-based skeleton (i.e. a skeleton containing both hydrogen and carbon) via a saturated carbon of sp³ hybridization. Thus, it is recommended to avoid compositions in which the mass ratio between, on the one hand, the amount of water in the aqueous phase and, on the other hand, the sum of the isocyanate and of the emulsifier according to the invention, is between 10⁻² and 0.5. If greater safety is desired, ratios of between 10⁻³ and 1 will be avoided.

The emulsions obtained have, for the isocyanate part, d₅₀ values at least equal to 0.05 micrometer and usually equal to 0.5 micrometer, and they have a d₅₀ and preferentially a d₈₀ value advantageously ≦(of not more than) 10 micrometers and preferably not more than 5 micrometers. The emulsion may be prepared with various aqueous phases and the aqueous phase of emulsions, suspensions or latices, which generally serves as a vector for the coreagents that are polycondensable with the isocyanate functions, may especially be used. The isocyanate emulsion may also be prepared separately and may be mixed with the emulsions, suspensions or latices of the coreagents.

Thus, the present invention is also directed toward isocyanate compositions in emulsion form, the aqueous phase of which also comprises compounds containing functions containing reactive hydrogen that are well known to those skilled in the art (alcohol, amine, sulfhydryl, etc. functions), in general one or more polyols. Except for in the case of latices, these compounds are polymers or polycondensates advantageously containing at least 2, preferably at least 4, more preferentially at least 5 and not more than 30, preferably not more than 15 and more preferentially 10 functions containing reactive hydrogen. The explanation given below for the polyols applies in general, mutatis mutandis, to all the functionalities of this type. The polyols that may be used are often polymers (or polycondensates) containing at least 2 hydroxyl (phenol or alcohol) groups, advantageously having a hydroxyl content of between 0.5 and 5 and advantageously between 1 and 3% (by mass; it is recalled that hydroxyl has a mass of 17).

It is recalled that curing is the formation of a three-dimensional network, which implies that at least one of the coreagents has a functionality of greater than 2. In the case of polyurethane networks, the isocyanate coreagent often has a high functionality (using the number-average mass Mₙ: from 3 to 8 and advantageously from 3.2 to 5.5).

Thus, except for the case of latices, which will be recalled later, the polyols advantageously comprise not more than 12 and preferably not more than 10 primary alcohol functions; for certain applications, from 2 to 4 are preferred (flexible coating). However, they may also comprise secondary or tertiary alcohol functions (in general not more than about 10, advantageously not more than 5 and usually not more than 2) which, in general, do not react or react only after the primers, and do so in the order: primary, secondary, tertiary.

Polyoses or polyosides [starch, cellulose, various gums (guar gum, carob gum, xanthan gum, etc.), etc.], especially in solid form, should be avoided. In the form of a texturing agent, and insofar as this does not inconvenience the emulsification and the stability of this emulsion, they may, however, be used to give particular properties (for example thixotropy, etc.) The polymer skeleton may be of diverse chemical nature, especially acrylic, polyester, alkyd, polyurethane, or even amide, including urea.

The polyol may comprise anionic groups, especially carboxylic or sulfonic groups, or may comprise no ionic groups.

On the occasion of the present invention, it was shown that the presence of an anionic carboxylate function (—CO₂⁻) significantly increased the drying kinetics, which is particularly advantageous for obtaining a short “dust-free” time, especially when working outdoors. A significant effect may be noted for a ratio of at least one carboxylic function per approximately 20 functions containing reactive hydrogen [alcohol or phenol function], advantageously for a ratio of one to about 10 and preferably for a ratio of one to about 5; however, it is desirable for this ratio to be at most equal to one function per one function, preferably one carboxylic function per two “-ol” functions. The counter-cations of the carboxylates advantageously satisfy the same preferences as those expressed for the counter-cations of the compound(s) according to the present invention.

The polyol may already be in aqueous or water-soluble or water-dispersible medium.

It may be an aqueous solution (which may be obtained especially after neutralization of the ionic groups) or an emulsion of the polymer in water or a dispersion of latex type.

It appears possible to disperse a standard polyisocyanate in a water-soluble polyol under certain formulation conditions (especially with a suitable ratio of pigment to paint binder). However, the use of standard polyisocyanates with water-dispersed polyols (such as latex or resin emulsion) often poses problems of incompatibility (flocculation, appearance of several phases, etc.). One of the many advantages of the preparation according to the invention is that it affords great freedom of choice for the formulation (physical form of the polyol, pigment-to-binder ratio, ease of incorporation into aqueous media).

Moreover, it has been observed through the usual values of coatings (especially chemical resistance and hardness) that the curing of the films was much greater when the polyol used was carboxylated.

In particular, latices may advantageously be used, especially nanolatices (i.e. latices of nanometric particle size [more specifically latices for which the d₅₀ is not more than about 100 nanometers]).

Thus, according to one of the particularly advantageous embodiments of the present invention, the polyol is advantageously a latex of nanometric size having the following characteristics:
d₅₀ of between 15 and 60 nm and advantageously between 20 and 40 nm;
carboxylate function of from 0.5% to 5% by mass;
“-ol” function: between 1% and 4% and advantageously between 2% and 3%;
solids content: between 25% and 40%;
a d₈₀ of less than 1 micrometer.

In addition, the latices, especially when their glass transition temperature is less than 0° C., advantageously less than −10° C. and preferably less than −20° C., make it possible to obtain with isocyanates, even aromatic isocyanates, weatherability and especially resistance to temperature variations.

The molar ratio between the free isocyanate functions and the hydroxyl functions is between 0.5 and 2.5, advantageously between 0.8 and 1.6 and advantageously between 1 and 1.4.

The latices (unfunctionalized optionally masked isocyanate latices) described in the French patent application filed on. Apr. 28, 1995, No. 95/05123 and in the reflex European patent application No. EP 0 739 961 give very good results.

Thus, advantageously, the latex particles have an acid function (advantageously carboxylic) content of between 0.2 and 1.2 milliequivalents/gram of solids and have an accessible alcohol function content of between 0.3 and 1.5 milliequivalents/gram.

The measurement of the acid or alcohol functionality is performed in a manner known per se by acid-based titration for the acid functions, whereas, for the alcohol functions, it is performed as for the other polyols used in this technical field on the dried organic phase and by the action of acetic anhydride, and measures the amount of acetic acid used to esterify the alcohol function (see, for example, standard ASTM E222).

Thus, as indicated in this document, latices consisting of particles bearing function(s) according to the invention, which are hydrophobic and advantageously have a size (d₉₀) generally of between 0.01 micrometer and 10 micrometers and preferably of not more than 5 micrometers or even not more than 2 micrometers, are preferred. The particles are calibrated, monodispersed and present in the latices in an amount ranging between 0.2% and 65% by mass relative to the total mass of the latex.

The weight-average molecular mass (M_{w} preferably determined by gel permeation chromatography, “GPC”) of the constituent polymers of the particles of the population A (latex containing “-ol” function acting as polyol) is advantageously between 5×10⁴ and 5×10⁶ and preferably 0.8×10⁵ and 2×10⁶.

The alcohol functions or the acid functions, preferably carboxylic acid functions, may also be obtained by hydrolysis of alcohol-generating functions (ester, ether, halide, etc.) or acid-generating functions (ester, anhydride, acid chloride, amide, nitrile, etc.).

The distribution between the various types of units advantageously satisfies the following rules:

The content of unit derived from the monomer constituted by said free alcohol containing an activated ethylenic function, and relative to the total amount of units of all kinds, is advantageously between 3% and 15% and preferably between 4% and 10% (on a molar basis, or equivalent).

According to one advantageous mode of the present invention, the unit is derived from an ester or an α-ethylenic acid, with a diol of which one of the alcohol functions remains unesterified. Said diol is advantageously an σ,σ′-diol, advantageously chosen from 1,4-butanediol, 1,3-propanediol and glycol.

It is desirable for said α-ethylenic acid to be an optionally substituted acrylic acid.

According to one preferred mode of the present invention, the content of unit derived from a free carboxylic acid (or a carboxylic acid in the form of a salt thereof), and relative to the total amount of units of all kinds, is between 2% and 10% (on a molar basis).

For economic reasons, it is often advantageous for said free acid to be an optionally monosubstituted acrylic acid or a salt thereof.

The particles derived from the present invention may consist of two different polymers, the first constituting the core and the second constituting the periphery. This type of particle may be obtained by epipolymerization [in which a latex seed is covered by surface polymerization (epipolymerization is occasionally referred to as superpolymerization)] of a different polymer. The core is occasionally referred to as the seed, by analogy with the phenomenon of crystallization. In this case, only the second polymer, i.e. the surface polymer, satisfies the concentration constraints for the various functions according to the resent invention.

The mass ratio ([CGFA]/[isocyanate]) between the isocyanates to be suspended (i.e. the subcomposition that is the vector for the isocyanate functions in the denominator) and said compound(s) comprising an anionic functional group and a polyoxygenated chain (numerator) is usually not more than 1/3, advantageously not more than about 20% and preferably not more than about 10%.

In the present description, the term “about” is used to emphasize the fact that when the figure(s) furthest to the right of a number are zeros, these zeros are positional zeros rather than significant figures, unless, of course, otherwise mentioned.

The mass ratio ([CGFA]/[isocyanate]) between the isocyanates to be suspended and the anionic functional group and a polyoxygenated chain is advantageously greater than 1% and preferably greater than 2%.

It is also desirable for the amount of said compound(s) comprising an anionic functional group and a polyoxygenated chain to correspond to a value of between 10⁻² and 1 and advantageously between 5×10⁻² and 0.5 atom of E per liter of composition a)+b).

Thus, the mass ratio ([CGFA]/[isocyanate]) between the isocyanates to be suspended and the anionic functional group and a polyoxygenated chain is advantageously at least equal to 2% and preferably at least equal to 4%, and not more than about 20% and preferably not more than about 10%; this mass ratio is thus advantageously between and about 20% and preferably between 4% and about 10%.

According to one particularly advantageous embodiment of the present invention, after dispersing or emulsifying, the sum of the constituents of the binder (i.e. the mass contents of the isocyanate(s), emulsifier(s) and polyol(s)) in water ranges from 30% to 70% relative to the total amount of the composition.

The isocyanates targeted by the invention especially comprise the compounds detailed below.

These compounds may advantageously contain structures that are common in this field, for example the prepolymers derived from the condensation of monomer(s) with polyfunctional alcohols (for example trimethylol-propane), in general triol (advantageously primary). However, they usually comprise structures of isocyanurate type, also known as trimer, uretidinedione structures, also known as dimer, biuret or allophanate structures or a combination of structures of this type on a single molecule or as a mixture.

If it is desired to substantially lower the solvent content of the composition, especially when it is in emulsion form, it is preferable to use mixtures of this type that are naturally (i.e. without addition of solvent) of low viscosity.

Compounds having this property are especially the derivatives (such as isocyanurate, also known as trimer, uretidinedione structures, also known as dimer, biuret or allophanate structures or a combination of structures of this type on a single molecule or as a mixture) partially and/or totally of aliphatic isocyanates whose isocyanate functions are linked to the skeleton via ethylene fragments (for example polymethylene diisocyanates, especially hexamethylene diisocyanate and those of arylenedialkylene diisocyanates whose isocyanate function is at least two carbons remote from the aromatic nuclei, such as (OCN—[CH₂]ₜ-Φ-[CH₂]ᵤ—NCO) with t and u greater than 1).

It is desirable for these compounds, or mixtures of compounds, to have a relatively low viscosity. As a guide, it may be recommended that, under normal conditions, it is not more than about 9000 centipoises (or milliPascal·seconds), advantageously not more than about 5000 centipoises (or millipascal·seconds), preferably not more than 3000 and more preferentially not more than 1500 centipoises (or millipascal·seconds). In point of fact, the lower the viscosity, the better the propensity to form emulsions.

When these viscosity values are not achieved, it is then often useful to bring the subcomposition within one of the above limits by adding a minimum amount of suitable solvent(s).

However, when reactive solvents (see below) are not used, it is preferable for the solvent content in the isocyanate subcomposition not to exceed 20% and advantageously 10% (one significant figure) by mass of the isocyanate composition.

When this is compatible with the application, the most suitable solvents are those that may conveniently be referred to as “reactive solvents” (since they have these two characteristics).

Reactive solvents that may be mentioned include aliphatic di- and triisocyanate monomers with a molecular mass at least equal to 200 (2 significant figures), advantageously at least equal to 250, and with a viscosity of not more than 500 mPa·s.

Among the solvents of this type that may be mentioned are lysine derivatives and especially LDI (lysine diisocyanate, derived from lysine ester), LTI (lysine triisocyanate, derived from the ester of lysine with ethanolamine), NTI (nonyl triisocyanate OCN—(CH₂)₄—CH(CH₂—NCO)—(CH₂)₃—NCO) and UTI (undecyl triisocyanate OCN—(CH₂)₅—CH(—NCO)—(CH₂)₅—NCO).

Mention may be made of polymethylene diisocyanate dimers optionally substituted on a methylene with an ethyl or a methyl (containing a uretidinedione ring), bis-dimers (trimer containing two uretidinedione rings) and their mixtures with each other and, where appropriate, with the tris-dimers (tetramer containing 3 uretidinedione rings). Such mixtures may be made by heating the monomers (see the international patent application published under No. WO 99/07765).

Mention may also be made of monoallophanates (dicondensates with a monoalcohol) derived from polymethylene diisocyanate optionally substituted on a methylene with an ethyl or a methyl, the two kinds of bis-allophanates (tetracondensates with a diol or, preferably, tricondensate with two monoalcohols containing two allophanate functions), and mixtures of 2 of the 3 specified species. For the synthesis of this type of product, reference may be made to the international patent application published under No. WO 99/55756.

Needless to say, mixtures of the various types of reactive solvent above may be used.

In other words, the viscosity of the isocyanate composition may be adjusted before mixing with the emulsifier to a value of not more than about 9000 centipoises (or milliPascal·seconds), advantageously not more than about 5000 centipoises (or millipascal·seconds), preferably not more than 3000 and more preferentially not more than 1500 centipoises (or millipascal·seconds) and even 1000 mPa·s by adding at least one of the above compounds. Namely, by cutting with an isocyanate composition having a viscosity of not more than 1200 mPa·s and at least 30% below the desired viscosity (i.e., respectively, 9000; 5000; 3000; 1500 and 1000 mPa·s), advantageously chosen from:
those comprising at least 10%, advantageously 20% and preferably 40% by mass of at least one aliphatic di- and polyisocyanate monomer with a molecular mass of greater than 200 and advantageously greater than 250 and with a viscosity of not more than 500 mPa·s;
those comprising at least 10%, advantageously 20% and preferably 40% by mass of at least one derivative containing a uretidinedione ring chosen from polymethylene diisocyanate dimers and bis-dimers optionally substituted on a methylene with an ethyl or a methyl;
those comprising at least 10%, advantageously 20% and preferably 40% by mass of at least one allophanate chosen from polymethylene diisocyanate monoallophanates optionally substituted on a methylene with an ethyl or a methyl;
those formed by mixing the three types of composition above.

As already mentioned above, the isocyanates concerned may be di-, poly- or even monoisocyanates. The majority of the components of the isocyanate subcomposition are usually derivatives from the oligocondensation of di-, tri- or even tetraisocyanate unit molecule(s). Such a molecule is termed a “monomer” and may be obtained by phosgenation of a primary diamine, optionally bearing one or even two other primary amine functions. Thus, such a molecule contains a diamino unit that is present in virtually all the oligocondensations and the vast majority of the conversions of the isocyanate functions. This observation makes it possible to refer to the number of diamino units especially to indicate the condensation state of the and of the oligo-condensates (including oligomers), or even of the polycondensates, even in the case of heterocondensates.

Thus, advantageously, the components of the isocyanate subcomposition have structures chosen from the isocyanurate structure, also known as trimer (involving three diamino units), uretidinedione structures, also known as dimer, biuret structures (involving 3 diamino units) or allophanate structures (involving 2 diamino units). Thus, these components usually have one of these structures or a combination of two or more of these structures on a single molecule or as a mixture.

The isocyanate monomers may be:

aliphatic, including cycloaliphatic and aryl-aliphatic, such as:
   simple aliphatic, polymethylene diisocyanate monomers containing polymethylene sequences (CH₂)_{ππ} in which ππ represents an integer from 2 to 10 and advantageously from 4 to 8, and especially hekamethylene diisocyanate, one of the methylenes possibly being substituted with a methyl or ethyl radical, as is the case for MPDI (methyl pentamethylene diisocyanate);
   partially “neopentyl” aliphatic partially cyclic (cycloaliphatic), isophorone diisocyanate (IPDI);
   cyclic aliphatic (cycloaliphatic) diisocyanate, those derived from norbornane or the hydrogenated forms (hydrogenation of the nucleus leading to a diamino ring subsequently subjected to an isocyanation, for example by phosgenation) of aromatic isocyanates;
   arylene dialkylene diisocyanates (such as OCN—CH₂-Φ-CH₂—NCO, a portion of which does not show any essential difference from aliphatics, i.e. those in which the isocyanate function is at least 2 carbons remote from the aromatic nuclei, such as (OCN—[CH₂]ₜ-Φ-[CH₂]ᵤ—NCO) with t and u greater than 1;
or alternatively aromatics such as tolylene diisocyanate (however, aromatic isocyanates function poorly as regards aqueous emulsification). On the other hand, their hydrogenated form is advantageous, such as 1,3- and 1,4-BIC (bisisocyanatocyclohexane).

The preferred polyisocyanates targeted by the technique of the invention are those in which at least one, advantageously two and preferably three of the conditions below are satisfied:
At least one, advantageously 2 and more preferably all of the NCO functions are linked to a hydrocarbon-based skeleton via a saturated (sp³) carbon, preferably with at least one and more preferentially at least two of the subconditions below:
   at least 1 and advantageously 2 of said saturated (sp³) carbons bears at least 1 and advantageously 2 hydrogen(s) (in other words, it has been found that better results were obtained when the carbon bearing the isocyanate function bore a hydrogen and preferably 2 hydrogens);
   at least 1 and advantageously 2 of said saturated (sp³) carbons themselves bear a carbon, which is advantageously aliphatic (i.e. of sp³ hybridization), itself bearing at least 1 and advantageously 2 hydrogen(s); in other words, it has been found that better results were obtained when the carbon bearing the isocyanate function was not in a “neopentyl” position.
All the carbons via which the isocyanate functions are linked to the hydrocarbon-based skeleton are saturated (sp³) carbons, which advantageously partially and preferably totally bear a hydrogen and preferably 2 hydrogens; in addition, it is advantageous for said saturated (sp³) carbons to be at least partially (advantageously 1/3 and preferably 2/3), and preferably totally borne themselves by a carbon, which is advantageously aliphatic (i.e. of sp³ hybridization), itself bearing at least 1 and advantageously 2 hydrogen(s); in other words, it has been found that better results were obtained when the carbon bearing the isocyanate function was not in a “neopentyl” position.
Those at least partially having an isocyanuric or biuret skeleton (whether this skeleton is derived from only one or from several monomers, see below) and more specifically structures of isocyanurate type, also known as trimer, uretidinedione structures, also known as dimer, biuret or allophanate structures or a combination of structures of this type on a single molecule or as a mixture, are particularly suitable.

When the polyisocyanates are relatively heavy, i.e. when they comprise at least 4 isocyanate functions, the first two conditions become:
at least 1/3 and advantageously 2/3 of the NCO functions are linked to a hydrocarbon-based skeleton via a saturated (sp³) carbon;
at least 1/3 and advantageously 2/3 of said saturated (Sp³) carbons bears at least 1 and advantageously 2 hydrogen(s); in other words, it has been found that better results were obtained when the carbon bearing the isocyanate function bore a hydrogen and preferably 2 hydrogens; in addition, it is advantageous for said saturated (sp³) carbons to be at least partially (advantageously 1/3 and preferably 2/3) and preferably totally borne themselves by a carbon, which is advantageously aliphatic (i.e. of sp³ hybridization), which itself bears at least 1 and advantageously 2 hydrogen(s); in other words, it has been found that better results were obtained when the carbon bearing the isocyanate function was not in a “neopentyl” position.

The isocyanates, especially aliphatic isocyanates, may react with some of the anionic compounds targeted by the invention to form anhydrides; these anhydrides are capable of regenerating the compounds of formula (II) and in certain cases react like masked isocyanates:
either by elimination of a molecule of water between two anionic functional groups and thus form a function of the type E-O-E (i.e. a pyrophosphoric sequence in the case of phosphates);
or by addition of the hydroxyl of non-neutralized or poorly neutralized acid functions, to the NCO function to form a function having the sequence —NH—CO—O-E. These compounds (mixed anhydrides between a carbamic acid and the anionic functional group) are also targeted by the present invention. They are often included in the definition of emulsifiers according to the present invention.

The first case corresponds to the case in which the first acidity has been imperfectly neutralized. The products obtained have good surfactant properties.

It especially gives pyrophosphates or pyrophosphatoids having the following formula (this product is included in the general formula of the compounds of the invention): 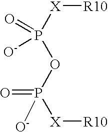
or of formula: 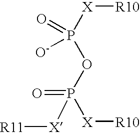
or even of formula:

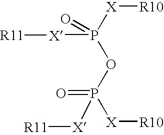

The above product is not directly included in the list of compounds targeted by the present invention, but constitutes a precursor of these compounds by hydrolysis thereof on contact with the aqueous phase.

The second case leads, starting with compounds of formula (II) in which E is phosphorus, R11 is hydrogen and X′ is an oxygen, to compounds of formula: 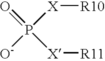
in which R11 has become —CO—NH-Iso;
in which Iso is a (poly)isocyanate residue (after elimination of an isocyanate function).

In general, Iso is such that Iso-NCO is an isocyanate oligomer (see above description) and comprises at least 2 and advantageously 3 isocyanate functions (in other words, Iso comprises at least one and advantageously 2 isocyanate functions in addition to the function that has reacted).

Thus, according to one advantageous variant of the present invention, the compositions according to the present invention have compounds derived from the reaction outlined above in an overall proportion, relative to one liter of isocyanate, of from 0.01 to 1, advantageously from 0.05 to 0.5 and preferably from 0.05 to 0.3 equivalent of anionic functional group, advantageously phosphorus-containing, preferably phosphoric of formula (I), even when R11 represents

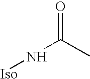

It is advantageous for the Iso radical to predominantly or totally afford an aliphatic bond with the same preferences as those outlined above as regards the isocyanates.

Thus, “Iso” usually represents the residue of an oligoisocyanate, advantageously of a product of reaction of a diisocyanate monomer to form compounds of biuret, uretidinedione, allophanate and/or isocyanurate (trimer) functionality. Iso may be a product of reaction of a diisocyanate monomer with a diol or polyol, advantageously a triol or a tetraol. However, in the latter cases, the urethanes produced are of high viscosity and function less well in emulsification.

Advantageously, Iso bears, besides the function featured in the formula, at least 1 and preferably at least 2 isocyanate functions, of which preferably at least 1 and more preferentially at least 2 are not masked.

Another aim of the present invention is to provide a process of the above type that makes it possible to emulsify the isocyanate composition targeted above.

Another aim of the present invention is to provide a process of the above type that makes it possible to emulsify the isocyanate composition by reducing the formation of foam.

This aim, and others that will become apparent hereinbelow, are achieved by means of an emulsification process that includes at least the following step:
the addition, advantageously with very moderate stirring (for example manual stirring), of the isocyanate(s) to an aqueous phase, such as the polyol+water mixture.

The emulsifier may be either in the aqueous phase or, preferably, in the isocyanate phase. In the first case, the reactions between isocyanate and anionic functional group are largely inhibited, but the second case is preferred.

This stirring is preferably manual or mechanical.

Moderate stirring suffices. This moderate stirring discourages the formation of foam. However, in addition to this effect, during the study that led to the present invention, it was shown that, all things being otherwise equal, the emulsification leads to a much lower production of foam than that which is formed with the usual emulsifiers. What is more, the foam that forms is unstable. This makes the emulsion more rapidly usable.

This emulsification is advantageously performed at a temperature of not more than 50° C. and preferably at room temperature.

It is desirable to perform, if necessary, an adjustment of the pH (to reach a value advantageously at least equal to 3, preferably to 4 and advantageously not more than 11 and preferably not more than 10, and thus advantageously between 3 and 11 and preferably between 4 and 10, during the emulsification. This adjustment makes it possible to reach an advantageous zone in which the first (or sole) acidity of each emulsifier according to the present invention is neutralized.

According to one advantageous variant of the present invention, the pigments (and especially the titanium dioxide) are dispersed in the polyol(s) before addition of the isocyanate.

The compositions according to the present invention are suitable for masking in dispersion, in which case the aqueous phase comprises one or more masking agent(s), either in dissolved form or in dispersion form, or as a mixture of the two forms. This technique has already been described in patents filed in the name of the Applicant, but it is possible to recall the main points thereof.

The masking group is the result of the reaction of a compound containing at least one reactive hydrogen with the isocyanate function of the polyisocyanates as defined above.

The masking agent, which may be a mixture of masking agents, is such that the masking reaction may be written as:
Iso-N═C═O+MA—H→Is-NH—CO(MA)
in which MA-H represents the masking agent;
in which MA- represents the masking group;
in which Iso is the residue bearing the isocyanate function under consideration.

Said masking agent contains at least one function bearing a labile hydrogen, or more exactly a reactive hydrogen, for which function a pKa may be defined, which corresponds either to the ionization of an acid, including the hydrogen of the functions, especially oxime, phenol and alcohols, or to the associated acid of a base, generally a nitrogenous base. The pKa of the function containing hydrogens is at least equal to 4, advantageously to 5 and preferably to 6, and is not more than 14, advantageously not more than 13, preferably not more than 12 and more preferably not more than 10, an exception needing to be made for lactams whose pKa is higher than these values and which constitute masking agents that are nevertheless acceptable, although not preferred for the invention.

Advantageously, the masking agent comprises only one labile hydrogen.

As nonlimiting examples of the masking agents according to the invention, mention may be made of hydroxylamine derivatives such as hydroxylsuccinimide and oximes such as methyl ethyl ketoxime, phenol derivatives or the like, amide derivatives such as imides and lactams, and also malonates or keto esters and hydroxamates.

Mention may also be made of nitrogenous heterocyclic groups containing 2 to 9 carbon atoms and, besides the nitrogen atom, from 1 to 3 other hetero atoms chosen from nitrogen, oxygen and sulfur. Heterocycles containing from 2 to 4 carbon atoms and from 1 to 3 nitrogen atoms are particularly preferred, such as pyrazolyl, imidazolyl, and triazolyl groups, these groups optionally being substituted with 1 to 3 substituents chosen from NH₂,NH(C₁-C₆ alkyl), N—(C₁-C₆ dialkyl), OH, SH, CF₃, C₁-C₆ alkyl, C₃-C₆ cycloalkyl, C₅-C₁₂ aryl, especially phenyl, C₆-C₁₈ aralkyl containing from 5 to 12 carbon atoms in the aryl group, especially benzyl or C₆-C₁₈ alkaryl containing from 5 to 12 carbon atoms in the aryl group.

1,2,3-Triazolyl, 1,2,4-triazolyl or 3,5-dimethyl-pyrazolyl groups are particularly preferred.

For the determination of the pKa values, reference may be made to “The determination of ionisation constants, a laboratory manual, A. Albert of E. P. Serjeant; Chapman and Hall Ltd., London”.

For the list of masking agents, reference may be made to Z. Wicks (Prog. Org. Chem., 1975, 3, 73 and Prog. Org. Chem., 1989, 9, 7) and Petersen (Justus Liebigs, Annalen der Chemie 562, 205, (1949).

The masking agents are advantageously such that the release temperature as measured by the octanol test is (obviously, without catalyst) at least equal to 100° C. and preferably to 120° C., and not more than 200° C., advantageously not more than 180° C. and more preferentially 170° C.

The masking agent(s) that is(are) useful in the reaction for protecting the isocyanate function may or may not be water-soluble. Even if it is only partial, this water solubility makes the process according to the present invention easy.

If they are sufficiently liquid to be readily dispersed in the aqueous phase, there is, in this case also, no difficulty; if not, it suffices to add a solvent to make it sufficiently liquid. Thus, for the liquid masking agents, a homogeneous or two-phase mixture may be obtained, depending on the water solubility of the masking agent.

As regards the solid products that are fully water-soluble at the reaction temperature of the reaction mixture, they may be used in unmodified form.

As regards the solid products that are only partially water-soluble at the reaction temperature, they may in general be used in unmodified form, where appropriate, to make the reaction medium more easily stirable by adding either a small amount of solvent to dissolve the protecting agent (which brings us back to the above question of the liquid masking agents) or an intermediary solvent (which is substantially inert under the operating conditions).

The masking agent may be introduced entirely into the bottom of the reactor with the water and the surfactant. It may also be introduced continuously into the reaction medium by coinjection with the polyisocyanate. In the latter case, the process will preferably be performed with an amount of blocking (or masking) agents in the reaction medium that is always sufficient to be able to mask the isocyanate function, optionally gradually as it is introduced when this introduction is gradual.

In any case, it will be sought to have a molar ratio (or more exactly an equivalent ratio) of masking agent MA/isocyanate function(s) which, taking the optional reagents into account (the water not being taken into account), has a value at least equal to a value close to the stoichiometry, and is generally between 0.8 and 2 and advantageously between 0.9 and 1.2 S.A. (i.e. Stoichiometric Amount).

However, when the masking agent may be used as (co)solvent and when it is compatible with the emulsion, the upper limit ratio is largely greater than 2 and the excess that has not reacted with the isocyanate functions may constitute up to 1/4 by mass of the final emulsion.

To promote the selectivity of the reaction, tertiary amines or any catalyst that promotes the masking reaction of the isocyanate function with the masking agent more than the reaction of the hydroxyls of water with the isocyanate functions may thus be introduced into the reaction medium.

Another aim of the present invention is to provide a process for applying the isocyanate-based composition to form a coating.

This aim, and others that will become apparent hereinbelow, are achieved by means of a process including the application of a preparation coat (i.e. of composition according to the invention comprising the aqueous phase and the constituents of the coat) whose thickness before drying is between 10 and 400 micrometers and advantageously between 50 and 200 micrometers, corresponding after drying to a thickness of between 5 and 150 micrometers and advantageously between 20 and 80 micrometers.

According to one advantageous embodiment, this process includes drying at from 20° C. to 60° C. for a time possibly ranging from ¼ to 24 hours.

Advantageously, this drying takes place in the presence of a solvent to aid the removal of the water.

According to one particularly advantageous embodiment of the present invention, the application is performed by spraying.

To improve the curing, the coats of coating (especially paints and varnishes) are subjected to baking at a temperature ranging from 80° C. to 200° C. for a time of not more than 3 hours, advantageously from 1 minute to 1 hour.

The lower end of the temperature range corresponds especially to the application based on unmasked isocyanate composition, whereas the upper end of the range corresponds to isocyanates masked with masking agents that become released at high temperature. As a guide, baking from half an hour to one hour at 140° C. corresponds to the demasking of the usual masking agent in the absence of catalysts. A person skilled in the art knows how to adapt the baking time to the chosen temperature.

The preparation of the surfaces is well known to those skilled in the art (for example phosphatations for ferrous steel compounds or chromatation for alumina-based surfaces). (Reference may be made, for example, to the following books: “Organic Coating Technology” volume II by H. F. Payne and “Paint Handbook” edited by G. E. Weismantel).

According to the present invention, it is thus possible to obtain coatings (especially paints or varnishes) that have the following technical characteristics (these values depend especially on the polyols used):

Coating implementation and characteristics
Dry thickness ISO2178: 45 μm
Support and treatment of the latter: steel treated by
phosphatation:
R461 plates from the supplier Q Pannel

| | |
|---|---|
| DIN 67530 test (these values are of | |
| interest only when a gloss paint is | Properties |
| desired, but not when a matt or | obtained |

| satin paint is desired) | minimum | usual |
|---|---|---|
| 20° gloss | | |
| 60° | 0.5 | 80 |
| König hardness ISO 1522 | 0.5 | 90 |
| Adherence test DIN 53151 | 10 s | 150 s |
| Impact strength test No. ISO 6272 | GT-1 | GT-5 |
| Direct | | |
| Inverse | 10 cm | >100 cm |
| Resistance to methyl ethyl ketone | 5 cm | >100 cm |
| (butanone) (double passage) | | |
| Outdoor behavior QUV | 20 | >200 |
| DIN 53384 | | |
| | 50 h | 800 h |

Octanol Test—Definitions

| | |
|---|---|
| “Release” (or | this is the lowest temperature at which the agent |
| “deblocking”) | for masking the masked isocyanate is displaced to a |
| temperature | proportion of 9/10 (mathematical round-up) by a |
| | primary monoalcohol (the primary alcohol is |
| | generally octanol). |
| Shelf life | To ensure a good shelf life, it is preferable to |
| | select masked isocyanate functions whose octanol |
| | test shows a “release” at 80° C., and |
| | advantageously at 90° C., of not more than 90%. |
| Reaction | The reaction is considered to be complete if it |
| progress | proceeds to more than 90%. |

Procedure

About 5 mmol of protected masked NCO equivalent to be evaluated are loaded into a Schott tube, with magnetic stirring.

2.5 to 3 ml of 1,2-dichlorobenzene (solvent) and the equivalent of 1-octanol (5 mmol, i.e. 0.61 g and optionally with the catalyst to be tested with the masking group) are added.

The reaction medium is then brought to the test temperature. It is then heated for 6 hours at the test temperature, so as to deblock and thus make the isocyanate functions reactive. Once the reaction is complete, the solvent is removed by distillation under vacuum and the residue is analyzed by NMR, Mass and infrared.

From these data, the percentage of masked isocyanate function condensed with the 1-octanol is evaluated.

The nonlimiting examples below illustrate the invention.

### EXAMPLE 1

### Description of the Emulsifiers Used

The emulsifiers used as examples of the present invention are phosphate esters of polyalkylene oxide methacrylate referenced TA1 and TA2: TA1 is a pentaethylene glycol methacrylate phosphate ester. TA2 is a pentapropylene glycol methacrylate phosphate ester. The process for obtaining TA1 and TA2 is described in WO 01/74909, in examples 1 and 2, respectively.

In the rest of the examples, the properties obtained using the compositions based on TA1 and TA2 will be compared with those of compositions containing fatty-alkyl-chain (C13) polyethylene oxide phosphate ester emulsifiers referenced TA3 and TA4. TA3 and TA4 differ in the monoester/diester ratio. The characteristics of the emulsifiers are given in table I.

TABLE I
Characteristics of the emulsifiers used in the examples
of the present invention

| | | Number of | |
|---|---|---|---|
| | | alkylene | Diester |
| | Nature | oxide units | content |
| TA1 | pentaethylene glycol | 5 | 6% |
| | monomethacrylate phosphate | | |
| | ester | | |
| TA2 | pentapropylene glycol | 5 | 6% |
| | monomethacrylate phosphate | | |
| | ester | | |
| TA3 | fatty-chain polyethylene | 9 | 30% |
| | phosphate ester | | |
| TA4 | fatty-chain polyethylene | 9 | 10% |
| | phosphate ester | | |

It follows that if reference is made to the formulae of the description nb_{N} and always zero, the values collated in the table below are obtained for the various parameters and radicals (the TAs are considered as being in acid form):

| | | | | | | | Number of | | | | | | | | R10: | |
|---|---|---|---|---|---|---|---|---|---|---|---|---|---|---|---|---|
| | Anionic group | | | | | | alkyleneoxyl | R10 | | | | | | | (nb_{C} − 4)/ | |
| | E | m | p | q | X | X′ | for X-R10 | nb_{C} | nb_{O} | n | D1 + D2 | R5 | Z1 | R1 | (nb_{O} + nb_{N}) | R11 |
| TA1 | P | 1 | 1.94 | 0.06 | O | O | 5 | 14 | 6 | 4 | H₂ | Single | —O—CO— | Methyl | 1.67 | =R10 |
| (Mn ≅ 395) | | | | | | | | | | | | bond | | vinyl | | |
| TA2 | P | 1 | 1.94 | 0.06 | O | O | 5 | 19 | 6 | 4 | One H | Single | —O—CO— | Methyl | 2.5 | =R10 |
| (Mn ≅ 469) | | | | | | | | | | | and one | bond | | vinyl | | |
| | | | | | | | | | | | CH₃ | | | | | |
| TA3 | P | 1 | 1.7 | 0.3 | O | O | 9 | 31 | 9 | 8 | H₂ | Single | —O— | Tridecyl | 3 | =R10 |
| (Mn ≅ 687) | | | | | | | | | | | | bond | | | | |
| comparative | | | | | | | | | | | | | | | | |
| TA4 | P | 1 | 1.9 | 0.1 | O | O | 9 | 31 | 9 | 8 | H₂ | Single | —O— | Tridecyl | 3 | =R10 |
| (Mn ≅ 596) | | | | | | | | | | | | bond | | | | |
| comparative | | | | | | | | | | | | | | | | |
| Comp B¹⁾ | P | 1 | 1.85 | 0.15 | O | O | 6.5 | 20.2 | 7.1 | 5.5 | H₂ | Single | O—(CO)_{0.63} | Carbon | 2.28 | |
| (Mn ≅ 501) | | | | | | | | | | | | bond | | No.: 6.7 | | |
| Comp. C | P | 1 | 1.83 | 0.17 | O | O | 6.9 | 21.9 | 7.4 | 5.9 | H₂ | Single | O—(CO)_{0.54} | Carbon | 2.42 | |
| Mn ≅ 530 | | | | | | | | | | | | bond | | No.: 7.6 | | |
| Comp E | P | 1 | 1.94 | 0.06 | O | O | 5 | 16.3 | 6 | 4 | H_{1.54} | Single | —O—CO | Methyl | 2.75 | =R10 |
| Mn ≅ 429 | | | | | | | | | | | (CH₃)_{0.46} | bond | | vinyl | | |
| Comp F | P | 1 | 1.84 | 0.16 | O | O | 6.6 | 23.9 | 7.2 | 5.6 | H_{1.41} | Single | O—(CO)_{0.59} | Carbon | 3 | |
| Mn ≅ 557 | | | | | | | | | | | (CH₃)_{0.59} | bond | | No.: 7.1 | | |

Compositions B, C, E and F form part of the invention in two respects: firstly the mean formula is included in the formula of the invention, and secondly they comprise at least 40% of a TA according to the invention.

### EXAMPLE 2

### Neutralization of the Emulsifiers

The emulsifiers described in Table I are partially neutralized with dimethylcyclohexylamine (DMCHA) before being incorporated into the polyisocyanate composition (see following examples). Beforehand, the curve of neutralization of the various acidities of the phosphate ester compounds with sodium hydroxide is established. The neutralization curve makes it possible also to determine the diester content in each of the emulsifiers presented in Table I.

The measurements consist in prediluting the phosphate esters in distilled water to 50%. A sample (<1 g) is then added to 40 ml of water. The acids are then neutralized with 1N sodium hydroxide solution using a titrimeter. The points of inflection of the “S” curves give the volume for neutralization of the successive acidities corresponding to the acidities of phosphoric acid. The difference in pKa between phosphoric acid and its various esters is low, in general not more than about half a pKa unit, and as such the neutralization waves may, to a first approximation, be considered as mixed. However, it may be mentioned that finer techniques make it possible to distinguish such differences. However, the value of such a measurement is low.

Thus, V1 is the volume of sodium hydroxide required for the first neutralization (corresponding to the first acidity of phosphoric acid, the pKa of which acidity is in the region of 2-3) and thus corresponds to the (equivalent) sum of the monoesters, diesters and of the residual phosphoric acid.
V1=M+D+P

Thus, V2 is the volume of sodium hydroxide required for the second neutralization (corresponding to the second acidity of phosphoric acid, pKa 7-8) and thus corresponds to the (equivalent) sum of the monoesters and of the residual phosphoric acid.
V2=M+P
V1−V2=D

Finally, V3 corresponds to the volume of sodium hydroxide required for the third neutralization (third acidity of phosphoric acid pKa 12-13) and thus corresponds (as equivalent) to the residual phosphoric acid.
P=V3.
M=V2−V3

$$Percentage diester ( equivalent \% ) = \frac{( {V}_{1} - {V}_{2} )}{{V}_{1}} \times 100.$$

The amount of DMCHA required to neutralize at least the first acidity of the various phosphate esters may thus be calculated. The result is presented in Table II.

TABLE II
Amount of DMCHA used to neutralize the first acidity of
the phosphate esters

| | Amount of DMCHA |
|---|---|
| | (g/g of emulsifier) |
| TA1 | 0.31 |
| TA2 | 0.31 |
| TA3 | 0.22 |
| TA4 | 0.22 |

The emulsifier+amine mixture is prepared using a roll-type stirrer for 2 hours, and is then left to stand overnight (12 hours) at 23° C. in stoppered flasks.

### EXAMPLE 3

### Preparation of the Self-emulsifying Polyisocyanates

The “hydrophilic” (self-emulsifying) polyisocyanates were prepared by adding to the polyisocyanate Tolonate®HDT (HDI trimer) the partially neutralized emulsifier compositions according to example 2 at different concentrations. Table III summarizes the emulsifying compositions prepared.

TABLE III
Emulsifying compositions prepared

| | | | | | | | Comp. G |
|---|---|---|---|---|---|---|---|
| | Comp. A | Comp. B | Comp. C | Comp. D | Comp. E | Comp. F | (reference) |
| TA1 | 76.63 | 39.7 | 32* | 0 | 38.3 | | |
| TA2 | 0 | 0 | 0 | 76.63 | 38.3 | 39.7 | |
| TA3 | 0 | 39.7 | 48.1 | 0 | 0 | 39.7 | 40.38 |
| TA4 | 0 | 0 | 0 | 0 | | | 40.38 |
| DMCHA | 23.37 | 20.6 | 19.9 | 23.37 | 23.4 | 20.6 | 19.24 |
| Total | 100 | 100 | 100 | 100 | 100 | 100 | 100 |

*i.e. 40% by mass of TA1/(TA1 + TA3)

The dissolution of the emulsifier in the cases of compound TA2 proceeds with much greater difficulty than in the case of TA1 (presence of aggregates that are difficult to disperse). This result confirms that the alkylene oxides that are preferred in the context of the present invention are the ethylene oxides.

### EXAMPLE 4

### Characterization of the Aqueous Polyisocyanate Emulsions

The dispersions obtained with the self-emulsifying polyisocyanates were characterized by measurement by laser granulometry (Malvern granulometer).

The test protocol used consists in taking 5 g of each formula and adding it to 45 g of water with stirring at 500 rpm using an inclined-paddle turbomixer for 3 minutes.

The analysis is then performed within the following 10 minutes so as to minimize the reactions between the isocyanate functions and the water.

### EXAMPLE 5

### Results of the Granulometric Analyses of the Polyisocyanate Emulsions Using TA1 as Emulsifier

Table IV presents the results of granulometric analyses as described in example 4 obtained with the self-emulsifying polyisocyanate compositions using TA1 as emulsifier (see description of the emulsifiers in Table III). The results show that for contents of greater than or equal to 8% by weight of partially neutralized emulsifiers (emulsifiers+amine), the emulsions obtained are stable, monopopulous and have small sizes and a narrow polydispersity. For the same mass content, the results obtained with the TA1-based compositions are thus better than or equivalent to those obtained with fatty-chain polyalkylene oxide phosphate esters of high molecular masses (comp. G).

### EXAMPLE 6

### Results of the Granulometric Analyses of Polyisocyanate Emulsions Using TA2 as Emulsifier

Table V presents the results of granulometric analyses as described in example 4 obtained with the self-emulsifying polyisocyanate compositions using TA1 and TA2 as emulsifier (see description of the emulsifiers in Table III).

For TA1, the results show that, for amounts of greater than or equal to 8% by weight of partially neutralized emulsifiers (emulsifier TA1+other emulsifiers+amine), the emulsions obtained are stable, monopopulous and have a narrow polydispersity.

For TA2, the results show that for amounts of greater than or equal to 14% by weight of partially neutralized emulsifiers (emulsifiers+amine), the emulsions obtained are stable, monopopulous and have a narrow polydispersity. This amount may be significantly reduced once the emulsifier composition used partly contains either a polyethylene oxide methacrylate phosphate ester TA1, or a fatty-chain polyalkylene oxide phosphate ester such as TA3. In this case, the results obtained in terms of size and particle size distribution are equivalent to those obtained with compositions based on fatty-chain polyalkylene oxide phosphate esters of high molecular masses (comp. G).

Thus, from the point of view of simple self-emulsification, TA1 presents very pronounced advantages compared with the comparative test product. TA2 shows, from this point of view, similar qualities, although markedly inferior to TA1. Thus, it does not show any loss of self-emulsifying property compared with the comparative test product.

TABLE IV
Characteristics of the polyisocyanate emulsions formulated using TA1

| | Emulsifier composition (%) | | | | | | | | |
|---|---|---|---|---|---|---|---|---|---|
| | Tolonate | | | | Comp. G | Nature of the | Particle size (±10%) | | |
| Ref. | HDT ® | Comp. A | Comp. B | Comp. C | (reference) | emulsion | D₁₀(nm) | D₅₀(nm) | D₉₀(nm) |
| Example 5a | 95 | 5 | | | | No emulsion | | | |
| Example 5b | 92 | 8 | | | | Monopopulous | 76 | 134 | 259 |
| Example 5c | 89 | 11 | | | | Monopopulous | 68 | 114 | 195 |
| Example 5d | 86 | 14 | | | | Monopopulous | 71 | 107 | 170 |
| Example 5e | 95 | | 5 | | | No emulsion | | | |
| Example 5f | 92 | | 8 | | | Monopopulous | 71 | 119 | 200 |
| Example 5g | 89 | | 11 | | | Monopopulous | 68 | 97 | 144 |
| Example 5h | 86 | | 14 | | | Monopopulous | 68 | 96 | 142 |
| Example 5i | 95 | | | 5 | | Bipopulous | 480 | 13 100 | 55 000 |
| Example 5j | 92 | | | 8 | | Monopopulous | 72 | 122 | 207 |
| Example 5k | 89 | | | 11 | | Monopopulous | 69 | 98 | 146 |
| Example 5l | 86 | | | 14 | | Monopopulous | 71 | 112 | 182 |
| Example 5m | 89 | | | | 11 | Monopopulous | 77 | 116 | 181 |

TABLE V
Characteristics of the polyisocyanate emulsions formulated using TA2

| | Emulsifier composition (%) | | | | | | | | |
|---|---|---|---|---|---|---|---|---|---|
| | Tolonate | | | | Comp. G | Nature of the | Particle size (±10%) | | |
| Ref. | HDT ® | Comp. D | Comp. E | Comp. F | (reference) | emulsion | D₁₀(nm) | D₅₀(nm) | D₉₀(nm) |
| Example 6c | 89 | 11 | | | | Bipopulous | 104 | 1850 | 7900 |
| Example 6d | 86 | 14 | | | | Monopopulous | 4400 | 6700 | 10 170 |
| Example 6f | 92 | | 8 | | | Bipopulous | 2600 | 5250 | 11 800 |
| Example 6g | 89 | | 11 | | | Monopopulous | 67 | 95 | 140 |
| Example 6h | 86 | | 14 | | | Monopopulous | 68 | 96 | 143 |
| Example 6j | 92 | | | 8 | | Bipopulous | 80 | 130 | 2000 |
| Example 6k | 89 | | | 11 | | Monopopulous | 76 | 114 | 172 |
| Example 6l | 86 | | | 14 | | Monopopulous | 68 | 96 | 143 |
| Example 6m | 89 | | | | 11 | Monopopulous | 77 | 116 | 181 |

### EXAMPLE 7

This example demonstrates that the emulsifiers described in the present invention generate less foam than the conventional anionic emulsifiers (fatty-chain polyalkylene oxide phosphate esters) during emulsification, which is of major interest in varnish and paint applications.

In order to quantify this effect, the following experiment was performed: the self-emulsifying polyisocyanate compositions referenced Example 5d and Example 5m of example 5 were emulsified to a proportion of 20% by mass in water with vigorous stirring (inclined-paddle mechanical stirrer, speed of 300 rpm for 5 minutes) 50 ml, of the emulsion are then transferred into a measuring cylinder. The height of foam is then measured as a function of time. The results are presented in Table VI.

TABLE VI
Volume of foam at rest generated during the
emulsification of the polyisocyanate compositions

| | Volume of foam | | |
|---|---|---|---|
| Polyisocyanate | at rest (ml) | | |
| composition | T0 | 10 mn | 20 mn |
| Example 5d | 90 | 65 | 55 |
| Example 5m | 90 | 80 | 75 |

After a few minutes at rest, the volume of foam generated with the TA1-based polyisocyanate composition was significantly lower than that of the polyisocyanate composition based on the TA3/TA4 mixture. These results clearly demonstrate the effect described above.

### EXAMPLE 8

### Evaluation of the Application Behavior

In order to illustrate the behavior of the polyisocyanate compositions of the present invention as two-pack varnishes, the following formulations were prepared.

The polyol used to make the varnishes is a polyol of acrylic type, Macrynal VSM 6299w/42wa from Solutia (characteristics: solids content=42%, % OH 4.02%).

The formulation for part “A” (hydroxylated) is as follows:

| | |
|---|---|
| Macrynal VSM 6299/42wa | 91.8 g |
| Aromatic solvent | 1.7 g |
| Demineralized water | 6.5 g |
| % OH (mass of function = 17 g) | 1.58% |
| calculated on the total part A | |

The varnish formulations are presented in Table VII. The self-emulsifying polyisocyanate compositions used are the compositions of example 5 referenced Example 5d and Example 5m.

TABLE VII
Composition of the two-pack varnishes

| | Composition | Formulation 8a | Formulation 8b |
|---|---|---|---|
| Part A | | 69.4 | 70.3 |
| (hydroxyl) | | | |
| Part B | Example 5d | 22.7 | |
| (isocyanate) | methoxypropyl | 7.9 | |
| | acetate | | |
| | Example 5m | | 22 |
| | methoxypropyl | | 7.7 |
| | acetate | | |
| | total | 100 | 100 |

The formulations were prepared in compliance with an NCO/OH ratio of 1.5. The viscosity is reduced by adding to formulations 8a and 8b an amount of distilled water of 14 g/100 g of formulation.

The formulations are applied to glass plates using a manual film drawer of 200 μm (wet thickness). The varnishes were then cured at 60° C. for 30 minutes and then left in an air-conditioned room (23° C., 50% RH).

The films have very comparable appearances (gloss). The change in the Persoz hardness of the two types of film at 1 hour and 24 hours after leaving the oven is given in Table VIII. The data indicate a comparable gain in hardness between the two systems (the values are given to ±5%).

TABLE VIII
Properties of the films obtained using
formulations 8a and 8b

| | Persoz hardness | Persoz hardness |
|---|---|---|
| Varnish | 1 hour after | 24 hours after |
| formulations | leaving the oven | leaving the oven |
| Formulation 8a | 214 | 322 |
| Formulation 8b | 191 | 319 |

Evaluation of the Direct Adherence Behavior

The emulsifier used is the product identified under the reference comp. A.

The isocyanate mixture tested (example 5c):

| | |
|---|---|
| Tolonate HDT: | 89% |
| Comp. A: | 11% |

Preparation of varnishes and paints:

The hydrophilic polyisocyanates were tested in aqueous-phase two-pack varnish and paint (primer) formulations.

For the varnishes, part “A” (hydroxylated) has as its composition the following formulation:

| | |
|---|---|
| Macrynal VSM 6299/42wa | 91.8 g |
| Solvesso 100 | 1.7 g |
| Demineralized water | 6.5 g |

(% OH calculated on the total part A: 1.58%)

The polyol Macrynal VSM 6299/42wa is an acrylic polyol emulsion (42% solids) sold by UCB. Solvesso 100 is a mixture of aromatic solvents sold by Exxon.

The formulations used for the hardeners are summarized below.

Hardener Formulations Used for Film Preparation

| | B1 | B2 |
|---|---|---|
| HDT + comp. G | 74 | |
| Ex 5c | | 74 |
| Methoxypropyl acetate (MPA) | 26 | 26 |
| Total | 100 | 100 |
| % NCO calculated | 13.6 | 14.2 |

The varnishes are formulated by complying with an NCH/OH functional ratio of 1.5. The viscosity of the formulation is adjusted by adding distilled water. The below gives the compositions of the varnishes thus obtained.

TABLE
Compositions of the varnish formulations

| | B1 | B2 |
|---|---|---|
| Hardener type | comparative | invention |
| Mass of part A | 69.4 g | 70.3 g |
| Mass of hardener | 30.6 g | 29.7 g |
| Addition of water | 14 g | 14 g |

The applications are performed under the following conditions:
thickness: 200 μm wet (manual film drawer)
evaporation for 15 minutes at room temperature and thermal curing for 30 minutes at 60° C.

The plates are then left in an air-conditioned room (23° C., 50% RH) before characterization.

On the glass plates, the adherence is evaluated by the grid method (ISO standard 2409).

Results

The results of the adherence measurements on glass plates of the varnishes are summarized below. The results speak for themselves.

Results of the adherence measurements (grid test of the aqueous-phase 2K PU varnishes on glass

| Test reference | Grid evaluation |
|---|---|
| Comparative B1 | 5 |
| Invention B2 | 1 |

0: good adherence; 5: poor adherence

### EXAMPLE 9

### Adherence to Metals of the Primer Without Pretreatment

For the paints (primers), the polyol has the composition:

| Ingredients | Composition % |
|---|---|
| Acrylic polyol | 22.3 |
| Mass content of OH | |
| (M.M. 17): 2.26% | |
| Functionality of˜7 | |
| Pigmentary paste | 62.42 |
| Additives | 1.1 |
| Total | 89.82 |

The composition of the hardener part is given below:

TABLE 5
Composition of the hardeners used for the primer
formulation

| | B3 comparative | B4 invention |
|---|---|---|
| HDT + comp. G | 80 | |
| Ex 5c | | 80 |
| MPA | 20 | 20 |
| Total | 100 | 100 |

The NCO/OH functional ratio is set at 1.4. The viscosity of the paint is adjusted at about 30 s to the DIN4 fraction by adding distilled water.

The paints are then applied using a low-pressure paint gun (dry thickness 70 μm) to R46 steel plates and AL46 aluminum plates precleaned with a cloth soaked with MEK, and then rinsed with ethyl acetate.

The test paints are cured for 30 minutes at 60° C. after 15 minutes of flash-off at room temperature, and are then left for 7 days at 23° C. and 50% relative humidity before being tested.

The measurements performed on the various systems are:
on the steel and aluminum plates, the adherence measurement via the plot peel method (ISO standard 4624) before and after immersion in deionized water at 25° C. in a Ford tank for 24 hours. To do this, the plates are prepared in the following manner:
   1) application to the painted surface of an adhesive Teflon-coated support of 50×50 mm² square pierced at its center with a hole 14 mm in diameter (support Teflon-coated on one face, tacky on the other face, and of thickness 170 μm)
   2) bonding of cylindrical steel studs 17 mm in diameter using a structural bonding agent reference Scotch-weld 9323 B/A from the company 3M
   3) curing of the structural adhesive for 24 hours at 23° C., 50% relative humidity.

The adherence is then evaluated by measuring the stud peel force using an Inströn 1185 tensile testing machine.

| Breaking load in Newtons before and after | |
|---|---|
| immersion | |
| B3 comparative | B4 invention |

| Substrate | Before | After | Before | After |
|---|---|---|---|---|
| Aluminum | ˜190 | ˜70 | ˜200 | ˜130 |
| Steel | ˜400 | ˜60 | ˜400 | ˜110 |

Immersion for 24 hours in water makes the adherence properties of the paint films drop, due to the swelling of the material by the water and the destruction of the metal/coating interphase. However, an improvement in the adherence properties of the paints made with the hardener according to the present invention is clearly observed in comparison with the material obtained with the comparative commercial product, before and after immersion, whether on steel or aluminum (factor 2 on the maximum breaking force). These results confirm the conclusions obtained previously on the improvement of the adhesion/adherence properties with the present invention.

1-53. (canceled)

54. A process for making a coating on a substrate comprise the step of coating said substrate with an isocyanate-based composition, wherein said coating comprises an emulsifier compound having a polyoxygenated anionic chain whose carbon number is not more than 25 and optionally not more than 20, and an anionic functional group.

55. The process as claimed in claim 54, wherein said coating is a direct-to-substrate coating.

56. The process as claimed in claim 54, wherein said coating is a primer, base or top coating without there being a conversion coat.

57. The process as claimed in claim 54, wherein said coating is a “top” coat without there being a primer.

58. The process as claimed in claim 54, wherein said coating is a “base” coat without there being a primer.

59. The process as claimed in claim 54, wherein said coating is a “base” coat without there being a primer or a conversion coat.

60. The process as claimed in claim 56, wherein said coating further contains compounds which, when used alone, are known to ensure conversion, optionally zinc potassium chromate or lead chromate.

61. The process as claimed in claim 54, wherein said coating further contains acicular and/or phyllitous compounds.

62. The process as claimed in claim 56, wherein said substrate is glass and metal.

63. The process as claimed in claim 54, wherein the anionic functional group has an atom chosen from the elements from columns VB (the phosphorus column) and VIB (the sulfur column) from a period at least equal to the third and at most equal to the fifth.

64. The process as claimed in claim 54, wherein the anionic functional group correspond to formula (I): 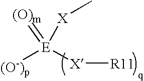
in which E is one of the atoms from columns VB (the phosphorus column) and VIB (the sulfur column) from a period at least equal to the third and at most equal to the fifth, or a carbon atom;
in which X represents a single bond, an oxygen, or a nitrogen, optionally substituted with a hydrocarbon-based radical bearing the open bond to attach said anionic group to the rest of the molecule;
in which X′ is chosen from a single bond and a metalloid, optionally a chalcogen optionally substituted;
in which R11 represents a hydrogen; another polyoxygenated chain identical to or different than that which will be attached to X; a hydrocarbon-based group, optionally bearing at most one other identical or different anionic functional group or a single bond providing a bond with another identical or different anionic functional group;
in which q represents 0 or 1;
in which p represents an integer between 1 and 2 (closed intervals, i.e. including the limits);
in which m represents 0 or an integer between 1 and 2 (closed intervals, i.e. including the limits);
with the condition that:
when E is a chalcogen (column VIB), q is equal to zero and the sum p+q+2m+1 is equal to 6 or 4
and that:
when E is an element from column VB (the phosphorus column), the sum p+q is equal to 2 and the sum p+q+2m+1 is equal to 5 or 3, optionally 5.

65. The process as claimed in claim 64, wherein said compound containing an anionic functional group has the formula (II) below: 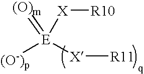
in which R10 represents said polyoxygenated chain and E is an atom from column VB.

66. The process as claimed in claim 65, wherein the number of carbons in said chain is linked to the number of oxygens and optionally to the number of nitrogens by the following relationship:
nb_{C}≦a·(nb_{O}+nb_{N})+4,
with nb_{C} representing the number of carbon atoms in said chain;
with nb_{N} representing the number of nitrogen atoms in said chain;
with nb_{O} representing the number of oxygen atoms in said chain; and
wherein the factor “a” is not more than 3, advantageously less than 3 and preferably less than 2.5.

67. The process as claimed in claim 66, wherein the number of carbons in said polyoxygenated chain is such that it corresponds to the relationship:
nb_{C}≧b(nb_{O}+nb_{N})+1,
with the factor “b” at least equal to 1, advantageously to 1.5 and preferably to 1.7.

68. The process as claimed in claim 65, wherein said polyoxygenated chain has between 2, and 7 alkenyloxyl units

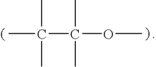

69. The process as claimed in claim 65, wherein said emulsifier compound has dual solubility: on the one hand in an aqueous phase and on the other hand in an isocyanate phase, both solubilities being equal to at least 5% by mass.

70. The process as claimed in claim 65, wherein, in the polyoxygenated chain R10, advantageously in said compound of formula (II), the ratio between the number of ethylenyloxyl units and the number of alkenyloxyl units is at least 2/3, advantageously 3/4 and preferably 100%.

71. The process as claimed in claim 65, wherein said compound(s) containing an anionic functional group comprise(s) at least one double bond, which is activated
either with a donor atom [nitrogen or oxygen as in the case of N-vinyls or vinyl ethers or esters];
or with an electron-withdrawing group, especially carbonyl, phosphonic or nitrile;
or with a double bond or an aryl.

72. The process as claimed in claim 65, wherein the polyoxygenated chain(s) according to the present invention correspond(s) to formula (III) below: 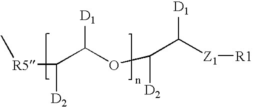
in which the multivalent radical R5 forms part of the polyoxygenated chain and provides the bonding between the chain and one, two or three anionic functional groups;
in which n is an integer chosen between 0 and 7, optionally between 2 and 6 (closed intervals, i.e. including the limits);
in which the values of D₁ and D₂ are different depending on the chain units and are methyls and hydrogens and cannot simultaneously be methyl;
the sum of the carbon atoms of the various groups D₁ and D₂ being not more than n/2 and optionally n/4.
in which Z₁ is a hydrophilic divalent group chosen from oxygen atoms or nitrogen atoms, carbonyloxyl divalent functions and amide functions [—N—CO— or —CO—N—] including urethane and urea, and from the divalent carbon-based groups, of up to 6 carbons, bearing at each end functions chosen from ether, amine, carbonyloxyl (O—CO—) or oxy]carbonyl (—CO—O—) (such as ester), amide, or ketone or aldehyde functions;
in which R1 represents said ipophilic end group and is hydrogen or hydrocarbon-based radicals.

73. The process as claimed in claim 72, wherein the end group R1 is a hydrocarbon-based group comprising at least one and optionally two carbons, with the proviso that when the limit of the end group is an oxygen engaged in an ether function, said end group comprises not more than eight carbons.

74. The process as claimed in claim 54, wherein said isocyanate-based composition comprises, for successive or simultaneous addition:
a) a subcomposition that is a vector of isocyanate functions;
b) an emulsifier containing at least one compound containing an anionic functional group and a polyoxygenated chain with a carbon number of not more than 25 and advantageously not more than 20; and
c) an aqueous phase.

75. The process as claimed in claim 74, wherein said isocyanate-based composition has a mass ratio between the emulsifier and the isocyanates of between 4% and 10%;
a catalyst
a polyol dispersed or dissolved in the aqueous phase c) in the form of a nanolatex.

76. The process as claimed in claim 75, wherein the nanolatex having the following characteristics:
d₅₀ between 15 and 60 nm;
carboxylate function of from 0.5% to 5% by mass;
-ol function: between 1% and 3%;
solids content: between 25% and 40%; and
a d₈₀ of less than 1 micrometer.

77. The process as claimed in claim 74, comprising the steps of
α) emulsifying the composition obtained by addition of the isocyanate composition a) and the emulsifier b) to the aqueous phase c).

78. The process as claimed in claim 77, wherein the aqueous phase contains one or more masking agents.

79. The process as claimed in claim 77, comprising the steps of:
β) applying the composition obtained from α) in the form of a coat with a thickness before drying ranging from 50 to 200 micrometers corresponding, after drying, to a thickness of between 20 and 80 micrometers.

80. The process as claimed in claim 79, further comprising the step of:
γ) drying at from 20° C. to 50° C. for ¼ to 3 hours.

81. The process as claimed in claim 80, further comprising the step of:
δ) baking at a temperature ranging from 80° C. to 200° C. for a period of not more than 3 hours and advantageously from 1 minute to 1 hour.
